(19) United States
(12) Patent Application Publication
(10) Pub. No.: US 2023/0142781 A1
(43) Pub. Date: May 11, 2023

(54) Photonic Ising Compute Engine with An Optical Phased Array

(71) Applicant: Raytheon BBN Technologies, Corp., Cambridge, MA (US)

(72) Inventors: Moe D. Soltani, Belmont, MA (US); James G. Leatham, Los Angeles, CA (US)

(21) Appl. No.: 17/985,020

(22) Filed: Nov. 10, 2022

Related U.S. Application Data
(60) Provisional application No. 63/278,033, filed on Nov. 10, 2021.

(51) Int. Cl. G06N 10/20; G02F 1/29; G02F 1/225

(52) U.S. Cl. CPC G06N 10/20; G02F 1/292; G02F 1/225

(57) ABSTRACT

A photonic processor computing engine device can include a photonic integrated circuit including an optical phased array having a plurality of radiating pixels that radiate optical signal beams. Each of the radiating pixels can include an optical antenna and an optical phase modulator. The engine can include an electronic control circuit positioned to receive the optical signal beams transmitted from the radiating pixels. The computing engine can further include an electronic feedback circuit in electrical communication with the focal plane array and the electronic control circuit to process a measured intensity of the optical signal beams received by the focal plane array from the optical phased array and provide a feedback signal to the electronic control circuit based on the measured intensity for recalibrating the optical phase modulators of the plurality of radiating pixels to control the phase of the optical signal beams emitted by the plurality of radiating pixels.

### CROSS-REFERENCE TO RELATED APPLICATION

This application claims the benefit of U.S. Provisional Application No. 63/278,033 which was filed on Nov. 10, 2021, which is incorporated by reference herein in its entirety.

### BACKGROUND

In computational complexity theory, computationally hard problems or computationally intensive problems are particular algorithms that cannot be solved efficiently by typical computer systems and methods. Such problems are also known as NP-hard problems (i.e., nondeterministic polynomial time hard problems). Such computationally hard problems cannot be solved “efficiently” if their running time is not upper bounded by a polynomial expression in the size of the input for the algorithm. In other words, NP-hard problems are problems whose solve time increases at a rate greater than polynomially with the size of the problem. Such problems appear in finance, economics, cryptography, medicine, biology, and other scientific and societal applications.

Due to computational inefficiency in normal computing systems and methods, these computationally hard problems tend to be solved using other methods. For example, such problems can be mapped to the Ising mathematical model in statistical mechanics. In the Ising model, solving for a ground state energy (e.g., lowest energy state) of the model using a Hamiltonian function known in the art can produce a solution for the Ising model and the NP-hard problem encoded as an Ising spin glass matrix in the Ising model. Solving the problem includes exciting (e.g., multiplying) the Ising spin glass matrix by combinations of binary values (e.g., spins) and iteratively arriving at the lowest energy state for the particular problem.

As can be appreciated by one skilled in the art, the XY model extends the concept of the Ising model and of the Ising spin glass by affording a continuum of values in the problem. Rather than being restricted to binary spin states with values of, for example, 0 and 1; classes of computationally hard problems projecting values to variable, non-binary, values can be solved in the same manner with this method, and are called XY model problems in the art. The description herein applies to both Ising spin models and XY models.

Various systems and methods have been explored to solve for the Hamiltonian energy in the Ising model in order to provide solutions for computationally hard problems. Approaches using cryogenics, electronics, arrays of coupled parametric oscillators, and Matrix-Vector-Multiply have been used for performing this analog or mixed-signal calculation. However, such approaches have been found to be unstable and show increased errors in implementation, or are unwieldly and/or power-hungry in that they consume undesirably large amounts of power. The approaches are further difficult to realize practically in bulk optics because of undesirable drift and difficult alignment issues. These approaches further incur losses when scaling with a factor of N², where N is the number of Ising spins in the Ising spin glass matrix. Conventional off-the-shelf spatial light modulators (SLM) and focal-plane arrays have shown promising and efficient calculation of Ising energy Hamiltonian with significantly large numbers of Ising variables. However, off-the-shelf spatial light modulators are bulky and slow in comparison to other on-chip photonic devices. Accordingly, quicker, more efficient, and more compact architectures useable for solving the ground state energy in an Ising model continue to be needed in the art.

### BRIEF DESCRIPTION OF THE DRAWINGS

Features and advantages of the subject technology will be apparent from the detailed description which follows, taken in conjunction with the accompanying drawings, which together illustrate, by way of example, features of the subject technology; and, wherein:

FIG. 1 shows a schematic view of an optical PIC radiation transmitter and receiver and a focal plane array according to one example of the present disclosure.

FIG. 2 shows a perspective view of a photonic integrated circuit-based optical device according to one example of the present disclosure.

FIG. 3 shows a perspective view of the interior of the photonic integrated circuit-based optical device in FIG. 2.

FIG. 4 shows a partial exploded view of the photonic integrated circuit-based optical device in FIG. 2.

FIG. 5 shows a schematic view of an optical phased array (OPA) of the photonic integrated circuit of FIG. 2.

FIG. 6 shows a plan view of a portion of the optical phased array of FIG. 5 according to one example of the present disclosure.

FIG. 7 shows a schematic view of photonic processor computing engine according to one example of the present disclosure.

FIG. 8 shows a schematic view of photonic processor computing engine of FIG. 7.

FIG. 9 shows a schematic view of photonic processor computing engine according to one example of the present disclosure.

FIG. 10 shows a plan view of a portion of an optical phased array according to one example of the present disclosure.

FIG. 11 shows a perspective view of a portion of the optical phased array of FIG. 10.

FIG. 12 shows a plan view of a portion of an optical phased array according to one example of the present disclosure.

FIG. 13 shows an isometric view of a photonic processor computing engine according to one example of the present disclosure.

FIG. 14 shows an isometric view of a photonic processor computing engine according to one example of the present disclosure.

FIG. 15 shows a computer implemented method according to one example of the present disclosure.

Reference will now be made to the examples illustrated, and specific language will be used herein to describe the same. It will nevertheless be understood that no limitation of scope is thereby intended.

### DETAILED DESCRIPTION

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

Given the above-described limitations of the current art, there exists a need for smaller, more efficient, and more reliable architectures for solving the ground energy state for an Ising spin glass matrix in order to better solve computationally intensive problems using a smaller and more scalable computational engine. Described herein are exemplary photonic phased array architectures integrated with Focal Plane Arrays (FPA) that together can perform as an efficient hardware implementation of an analog compute/processor computing engine for the calculation of energy Hamilton of an Ising spin glass matrix in an Ising model and finding the Ising spin glass matrix's ground state energy. This application describes new devices, systems, and methods incorporating a photonic optical phased array (OPA) in a hardware architecture that can calculate the Ising Hamiltonian in real time with high computational efficiency.

In one example of the present disclosure, a photonic processor computing engine device can include a photonic integrated circuit (PIC). The photonic integrated circuit (PIC) can include an optical phased array (OPA) comprising a plurality of radiating pixels that radiate optical signal beams based on electromagnetic radiation. Each of the plurality of radiating pixels can include an optical antenna and an optical phase modulator. The photonic integrated circuit (PIC) can further include an electronic control circuit in electrical communication with the optical phased array (OPA) to calibrate and control the optical phase modulators of the optical phased array (OPA) and a focal plane array (FPA) positioned to receive the optical signal beams transmitted from the plurality of radiating pixels. The photonic integrated circuit (PIC) can further include an electronic feedback circuit in electrical communication with the focal plane array (FPA) and the electronic control circuit to process a measured intensity of the optical signal beams received by at least a portion (e.g., a defined portion) the focal plane array (FPA) from the optical phased array (OPA) and provide a feedback signal to the electronic control circuit based on the measured intensity for recalibrating the optical phase modulators of the plurality of radiating pixels to control the phase of the optical signal beams emitted by the plurality of radiating pixels.

In some examples, the photonic processor computing engine device can further include a lens assembly comprising one or more lenses and disposed between the photonic integrated circuit (PIC) and the focal plane array (FPA) to project the far field of the optical signal beams from the radiating pixels onto the focal plane array (FPA).

In some examples, the photonic processor computing engine device can further include a plurality of layers. The plurality of layers can include a photonic layer comprising the optical phased array (OPA) and an electronic layer comprising the electronic control circuit disposed on a surface of the photonic layer. The electronic control circuit can include a digital read-in integrated circuit (DRIIC) board in electrical communication with each of the optical phase modulators of the radiating pixels, the digital read-in integrated circuit being configured to apply voltages to control each of the optical phase modulators.

In some examples, the electronic layer comprises one or more CMOS circuits.

In some examples, the photonic integrated circuit PIC can further include a plurality of optical waveguides, each optically coupled to one of the plurality of radiating pixels of the optical phased array (OPA) and a cascading waveguide tree comprising an electromagnetic radiation inlet configured to receive electromagnetic radiation from an electromagnetic radiation source, and a plurality of waveguide branches in optical communication with the electromagnetic radiation inlet and the plurality of optical waveguides.

In some examples, the photonic processor computing engine device can further include a main optical waveguide in communication with an electromagnetic radiation source, and configured to receive electromagnetic radiation from the electromagnetic radiation source and a plurality of branch optical waveguides each optically coupled to the main optical waveguide and two or more radiating pixels of the plurality of radiating pixels.

In some examples, the electronic control circuit controls the optical phase modulators of the optical phased array (OPA) to map a computationally hard problem as an Ising spin glass matrix to the radiating pixels.

In some examples, the electronic control circuit can control the optical phase modulators to have phase values of either 0 or π as Ising spin values for the Ising spin glass matrix mapped to the radiating pixels.

In some examples, the PIC further comprises an optical attenuator or amplifier, and the electronic control circuit independently controls each of the optical phase modulators and attenuators/amplifiers to independently control an amplitude and phase of each of the optical signal beams of the plurality of radiating pixels to represent an Ising Spin Glass matrix of the Ising Spin Model mapped to the radiating pixels.

In some examples, the photonic processor computing engine device can further include the electronic feedback circuit programmed to provide feedback of the measured intensity of the optical signal beams received by at least a portion (e.g., a defined portion) the focal plane array (FPA) to the electronic control circuit.

In some examples, the electronic control circuit can be programmed to process the feedback to adjust the setting of each of the optical phase modulators of the plurality of radiating pixels to the ground energy state of the Ising spin glass matrix mapped to the radiating pixels.

In some examples, the electronic control circuit can control the optical phase modulators to have phase values of from −π to π as values for an XY Hamiltonian model mapped to the radiating pixels.

In some examples, PIC further comprises an optical attenuator or amplifier, and the electronic control circuit independently controls each of the optical phase modulators and attenuators/amplifiers to independently control an amplitude and phase of each of the optical signal beams of the plurality of radiating pixels to represent an XY Hamiltonian model mapped to the radiating pixels.

In some examples, the electronic feedback circuit is programmed to provide feedback of the measured intensity of the optical signal beams received by at least a portion (e.g., a defined portion) the focal plane array (FPA) to the electronic control circuit, and the electronic control circuit is programmed to process the feedback to adjust the setting of each of the optical phase modulators of the plurality of radiating pixels to a signal that correlates to the ground energy state of the XY Hamiltonian model mapped to the radiating pixels.

In some examples, the focal plane array (FPA) can include a plurality of pixels, wherein the plurality of image pixels are fewer in number than the plurality of radiating pixels of the optical phased array (OPA).

In some examples, the photonic processor computing engine device can further include a plurality of the photonic integrated circuits (PIC), each comprising an optical phased array (OPA) comprising a plurality of radiating pixels that radiate optical signal beams based on electromagnetic radiation. The pixels can each include an optical antenna and an optical phase modulator. The photonic processor computing engine device can further include an electronic control circuit in electrical communication with the optical phased array (OPA) to calibrate and control the optical phase modulators of the optical phased array (OPA). The focal plane array (FPA) is positioned to receive the optical signal beams transmitted from the plurality of radiating pixels of one or more of the plurality of photonic integrated circuits (PIC).

In some examples, the photonic processor computing engine device can further include a plurality of focal plane arrays (FPA), each positioned to receive the optical signal beams transmitted from the plurality of radiating pixels of one or more of the plurality of photonic integrated circuits (PIC).

In another example of the present disclosure, a photonic processing system can include an electromagnetic radiation source. The system can further include a photonic processor computing engine device can include at least one photonic integrated circuit (PIC). The photonic integrated circuit (PIC) can include an optical phased array (OPA) comprising a plurality of radiating pixels that radiate optical signal beams based on electromagnetic radiation. Each of the plurality of radiating pixels can include an optical antenna and an optical phase modulator. The photonic integrated circuit (PIC) can further include an electronic control circuit in electrical communication with the optical phased array (OPA) to calibrate and control the optical phase modulators of the optical phased array (OPA) and at least one focal plane array (FPA) positioned to receive the optical signal beams transmitted from the plurality of radiating pixels. The system can further include at least one processor in electronic communication with the optical phase modulators and the focal plane array and a memory device including instructions that, when executed by the at least one processor, cause the system to (1) measure an intensity of the optical signal beams received by at least a portion (e.g., a defined portion) the focal plane array (FPA) from the optical phased array (OPA); (2) provide a feedback signal to the optical phase modulators based on the measured intensity of the optical signal beams; (3) control the optical phase modulators of the plurality of radiating pixels to control the phase of the optical signal beams emitted by the plurality of radiating pixels to reach a condition correlated to a ground energy state; and (4) retrieve the phases of the optical phase modulators at the condition correlated to the ground energy state.

In another example of the present disclosure, a computer implemented method of solving computationally hard problems is disclosed using a photonic processor computing engine device comprising an optical phased array (OPA) and a focal plane array (FPA). The method can include emitting optical signal beams from a plurality of radiating pixels of the optical phased array (OPA) to the focal plane array (FPA), each of the radiating pixels comprising an optical antenna and an optical phase modulator. The method can include measuring an intensity of the optical signal beams received by at least a portion (e.g., a defined portion) the focal plane array (FPA) from the radiating pixels of the optical phased array (OPA). The method can include providing a feedback signal to the optical phase modulators based on the measured intensity of the optical signal beams. The method can include energizing the optical phase modulators of the plurality of radiating pixels to control the phase of the optical signal beams emitted by the plurality of radiating pixels. The method can include retrieving the phases of the optical phase modulators at the desired measurement of the intensity at the focal plane array. The desired measurement of the intensity can be set at a predetermined threshold value desired by the user or can be a predetermined value based on the ground energy state. In other words, the phase values can be retrieved when the state of the

In some examples the method can include controlling, individually, each of the optical phase modulators such that optical signal beams radiating from each of the radiating pixels have binary phase values of either a first value or a second value. The method can further include providing feedback of the measured intensity of the optical signal beams received by at least a portion (e.g., a defined portion) the focal plane array (FPA) to the optical phase modulators. The method can further include processing the feedback signal to recalibrate the optical phase modulators of the plurality of radiating pixels to the condition that correlates to the ground energy state of the Ising spin glass mapped to the radiating pixels.

In some examples of the method the optical phase modulators can have phase values of either 0 or π as Ising spin values for each radiating pixel.

In some examples the method PIC further comprises an optical attenuator or amplifier, and each of the optical phase modulators and optical attenuators/amplifiers are independently controlled to control an amplitude and phase of each radiating optical signal beam of each of the plurality of radiating pixels to represent an Ising Spin Glass matrix of the Ising Spin Model mapped to the radiating pixels.

In some examples of the method, the optical phase modulators can have phase values from −π to π as values in the XY Hamiltonian model for each radiating pixel.

In some examples of the method the PIC further comprises an optical attenuator or amplifier, and each of the optical phase modulators and optical attenuators/amplifiers are independently controlled to control an amplitude and phase of each radiating optical signal beam of each of the plurality of radiating pixels to represent an XY Hamiltonian model mapped to the radiating pixels.

In another example of the present disclosure, a non-transitory machine-readable storage medium can include instructions embodied thereon, wherein the instructions, when executed by at least one processor, cause a photonic processing engine comprising an optical phased array (OPA) and a focal plane array (FPA) to: (1) emit optical signal beams from a plurality of radiating pixels of the optical phased array (OPA) to the focal plane array (FPA), each of the radiating pixels comprising an optical antenna and an optical phase modulator; (2) measure an intensity of the optical signal beams received by at least a portion (e.g., a defined portion) of the focal plane array (FPA) from the radiating pixels of the optical phased array (OPA); (3) provide a feedback signal to the optical phase modulators based on the measured intensity of the optical signal beams; (4) control the optical phase modulators of the plurality of radiating pixels to control the phase of the optical signal beams emitted by the plurality of radiating pixels; and (5) retrieve the phases of the optical phase modulators at the condition that correlates to the ground energy state.

In some examples, the non-transitory machine-readable storage medium of can further execute instructions to individually control each of the optical phase modulators such that optical signal beams radiating from each of the radiating pixels have binary phase values of either a first value or a second value; provide feedback of the measured intensity of the optical signal beams received by at least a portion (e.g., a defined portion) of the focal plane array (FPA) to the optical phase modulators; and process the feedback signal to recalibrate the optical phase modulators of the plurality of radiating pixels to a condition that correlates to the ground energy state of the Ising spin glass matrix mapped to the radiating pixels.

In some examples of the storage medium, the optical phase modulators can have phase values of either 0 or π as Ising spin values for each radiating pixel.

In some examples of the storage medium, the instructions, when executed by at least one processor, further cause the photonic processing engine to individually control phase (and amplitude) of each radiating optical signal beam of each of the plurality of radiating pixels to represent an Ising Spin Glass matrix of the Ising Spin Model mapped to the photonic processor computing engine device.

In some examples of the storage medium, the optical phase modulators can have phase values from −π to π as values in the XY Hamiltonian model for each radiating pixel.

In some examples of the storage medium, the instructions, when executed by at least one processor, further cause the photonic processing engine to individually control phase (and amplitude) of each radiating optical signal beam of each of the plurality of radiating pixels to represent an XY Hamiltonian Model mapped to the photonic processor computing engine device.

### Photonic Integrated Circuit and Optical Phased Array

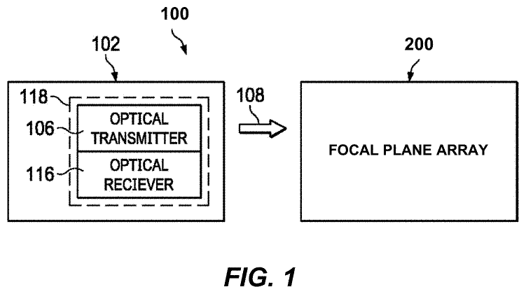

FIGS. 1-15, described below, and the various examples used to describe the principles of the present disclosure are by way of illustration only and should not be construed in any way to limit the scope of this disclosure. Those skilled in the art will understand that the principles of the present disclosure can be implemented in any type of suitably arranged device or system.

Transmitting OPAs utilize antenna elements to form transmitted optical signal beams, where phases associated with the antenna elements can be controlled or adjusted to perform beam shaping, beam pointing, or beam steering. Silicon integrated photonic phase and amplitude modulated arrays (“optical phased arrays”) have been extensively investigated and demonstrated in the literature for a wide range of applications. The antenna elements and various other components of, or associated with, an OPA can be implemented using one or more PICs. This disclosure provides a new application for an optical phased array to provide a design that is provided to support solving of an Ising Model and the Hamiltonian energy (e.g., ground state energy) of an Ising spin glass matrix thereof. The principles described herein can have various advantages or benefits depending on the implementation. For example, when compared to the current knowledge in the art, the designs and implementations described herein can be provided to solve Ising model problems more efficiently and with a more compact and scalable architecture. The size and low power required to drive the architectures described herein allow for scalability of the described examples to other sizes for use in multiple situations. The examples described herein can further calculate the Ising Hamiltonian of an Ising spin glass matrix in real time with high computational “efficiency” as defined in computational complexity theory.

The OPA can include an array of silicon nano-antenna elements or other antenna elements, where relative phases and amplitudes of the radiation emitting from the antenna elements can be electronically individually controlled for mapping to the Ising spin glass matrix of an Ising model. The Ising spin glass matrix can be a state of spins, or in other words, a set of phase values set for the antenna elements as an initial condition to solving the Ising model problem. In some cases, the array can support a unit cell architecture with low-power resonant micro-rings or other modulators so that phases and amplitudes of each antenna element can be independently calibrated and controlled. If desired, a supercell design (which logically groups multiple antenna elements and related components into multiple supercells) can help provide routing simplicity and enable scalability in size. Also, in some cases, amplitude modulation of each supercell can be used to provide control of the transmit power.

FIG. 1 illustrates the configuration used to facilitate calculation of Ising model problems. For example, FIG. 1 illustrates an exemplar schematic of a system 100 supporting photonic integrated circuit-based optical beam transmission according to this disclosure. As shown in FIG. 1, the system 100 can include a node 102 that can transmit and/or receive data using optical communications. The node 102 can engage in unidirectional communication with another element (e.g., another node, optical phased array, image sensor, or focal plane array (FPA) 200) in which node 102 only transmits optical signals or beams to the other element. However, it will be appreciated that, the node 102 can further engage in bidirectional communication where the node 102 is capable of both transmission and reception of optical signal beams.

The node 102 in this example can include the elements capable of performing required functions. For example, the optical transmitter 106 can encode information onto the optical signal beams 108, such as by using suitable amplitude, phase, frequency, and/or other modulation(s) of light. The optical signal beams 108 can be transmitted through free space or other transmission medium to the focal plane array (FPA) 200, where an optical receiver, pixel, image sensor, or other electromagnetic radiation sensing element receives and processes the optical signal beams 108. For instance, the focal plane array (FPA) 200 can identify the amplitude, phase, frequency, and/or other modulation(s) of light in the optical signal beams 108 and use the identified modulation(s) or characteristics to produce feedback or other data signals for further processing. The FPA 200 can further analyze levels, phases, amplitudes, or other characteristics of the optical signal beam from the node 102 for purposes of calculating feedback or other data signals. Any suitable type of modulation/demodulation scheme can be used here to encode and decode the optical signal beams 108.

The optical transmitters, receivers, and transceivers described in this disclosure can be used in a large number of applications, as recited above. In general, this disclosure is directed toward using optical transmitters, receivers, or transceivers to solve an Ising model problem not limited to any particular problem that can be mapped to the Ising model. However, this disclosure does not intend to exclude any other possible applications of the optical transmitters, receivers, and transceivers of various nodes.

Although FIG. 1 illustrates one example of a system 100 supporting photonic integrated circuit-based communication with a focal plane array, various changes can be made to FIG. 1. For example, while only one node 102 in communication with one focal plane array 200 are shown here, the system 100 can include any suitable number of nodes and any suitable number of focal plane arrays that engage in any suitable unidirectional, bidirectional, or other communications with each other. Also, each node of the system 100 can include any suitable number of optical transmitters, receivers, or transceivers that communicate via any number of optical signal beams. In addition, the system 100 is shown in simplified form here and can include any number of additional components in any suitable configuration as needed or desired.

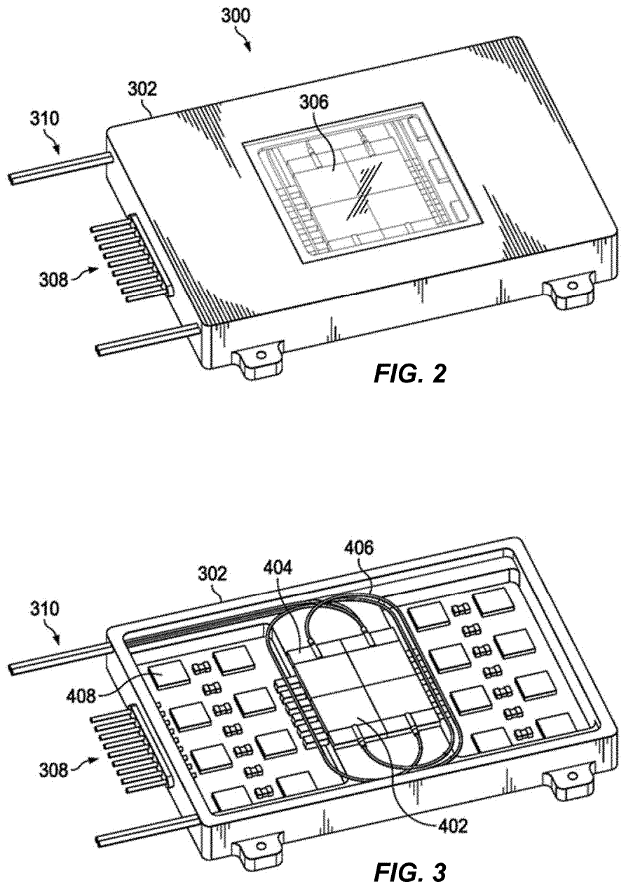

FIGS. 2-4 illustrate an example photonic integrated circuit-based optical device 300 according to this disclosure. The optical device 300 can be used in any suitable apparatus and in any suitable system used for optical communication from or to an optical phased array (OPA).

As shown in FIG. 2, the optical device 300 can include a package 302, which surrounds and protects electronic and optical components of an optical transmitter 106, optical receiver 116, or optical transceiver 118. The package 302 can be formed from any suitable material(s), such as one or more metals, and in any suitable manner. The package 302 can also have any suitable size, shape, and dimensions and can have any suitable form without any intended limitation.

The package 302 can include an optical window 306, which is at least partially optically transparent with respect to the optical signal beams being transmitted from or received by the optical device 300). The optical window 306 can be formed from any suitable material(s), such as borosilicate glass or other glass, and in any suitable manner. The optical window 306 can also have any suitable size, shape, and dimensions.

The package 302 can also include one or more electrical connections 308 that can be used to transport one or more electrical signals between the interior and the exterior of the package 302. The one or more electrical signals can be used here for any suitable purposes, such as to control one or more operations of the optical device 300. As a particular example, the one or more electrical signals can be used for controlling amplitude or phase modulators to control phases or amplitudes of optical signal beams from the antenna elements of a photonic integrated circuit in the optical device 300. The package 302 can further include one or more optical inputs/outputs 310 (e.g., fiber optics), which can be used to provide one or more input signals to the optical device 300 and/or receive one or more output signals from the optical device 300. The one or more input signals can carry information to be transmitted from the optical device 300, or can contain continuous wave electromagnetic radiation, such as coherent constant amplitude light which is amplitude or phase modulated within the device. The one or more output signals can carry information received at and recovered by the optical device 300. In this example, there are two fiber inputs/outputs 310, although the optical device 300 can include a single fiber input/output 310 or more than two fiber inputs/outputs 310. Note, however, that no fiber inputs/outputs 310 are needed if all optical generation and processing occurs using components within the package 302, in which case the electrical connections 308 can be used to transport information to or from the optical device 300.

As shown in FIG. 3, a photonic integrated circuit 402 is positioned within the package 302, namely at a location where the photonic integrated circuit 402 can transmit and/or receive optical signal beams through the optical window 306. As described below, the photonic integrated circuit 402 can be used to support transmission and/or reception of optical signal beams, depending on the design of the photonic integrated circuit 402. The photonic integrated circuit 402 can also support a number of additional optical functions as needed or desired. The photonic integrated circuit 402 can be formed from any suitable material(s), such as silicon, indium phosphide, or gallium arsenide, and in any suitable manner. The photonic integrated circuit 402 can also have any suitable size, shape, and dimensions. As a particular example, the photonic integrated circuit 402 can be square and have an edge length of about 40 mm, although any other suitable sizes and shapes can be used here.

Fiber mounts 404 can be used to couple to optical fibers 406 at locations where the optical fibers 406 can provide optical signals to and/or receive optical signals from the photonic integrated circuit 402. For example, the optical fibers 406 can provide optical signals from a source laser to the photonic integrated circuit 402 for use during outgoing transmissions of optical signal beams. The optical fibers 406 can also or alternatively provide optical signals received by the photonic integrated circuit 402 to a receiver for processing. Each fiber mount 404 can include any suitable structure configured to be coupled to an optical fiber 406. Each optical fiber 406 represents any suitable length of an optical medium configured to transport optical signals to or from a photonic integrated circuit 402. Note that while four fiber mounts 404 and optical fibers 406 are shown here, the optical device 300 can include, one, two, three, or more than four fiber mounts 404 and optical fibers 406. Also note that no fiber mounts 404 and optical fibers 406 can be needed if all optical generation and processing occurs using components of the photonic integrated circuit 402.

An electronic control board 408 includes electronic components, such as one or more integrated circuit chips and other components, that control the operation of the photonic integrated circuit 402. For example, the electronic control board 408 can include one or more components that calculate desired phases and/or amplitudes for optical signal beams to be generated by antenna elements of the photonic integrated circuit 402, which imparts the Ising spin glass onto the Ising model (or XY model values onto the XY model). Additionally or alternatively, the electronic control board 408 can include one or more components that calculate desired phases to be applied to optical signals received by antenna elements of the photonic integrated circuit 402, which allows the electronic control board 408 to control wavefront reconstruction operations, such as to minimize the energy Hamiltonian. The electronic control board 408 includes any suitable components configured to perform one or more desired functions related to a photonic integrated circuit 402.

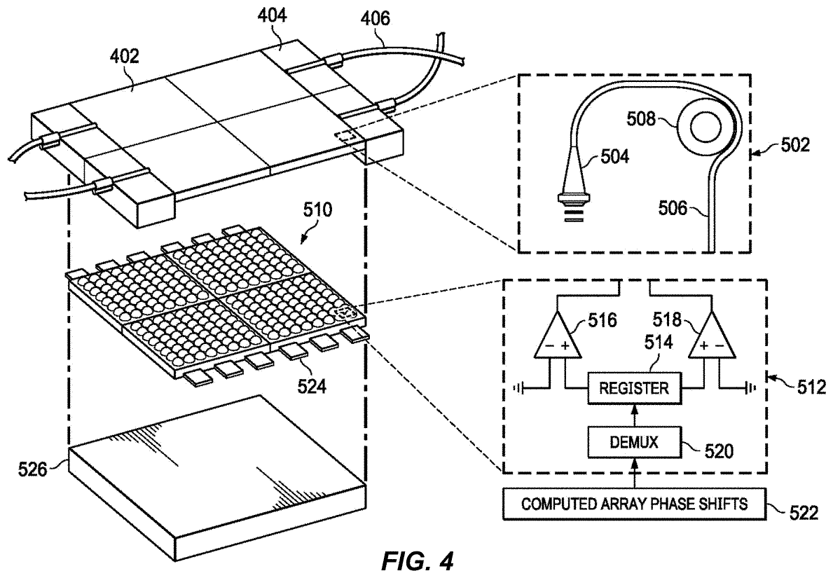

As shown in FIG. 4, the photonic integrated circuit 402 itself can include a number of array elements 502, which represent PIC unit cells of the photonic integrated circuit 402. Each array element 502 can be configured to transmit or receive one or more optical signals. The photonic integrated circuit 402 can include any suitable number of array elements 502, possibly up to and including a very large number of array elements 502. In some embodiments, for example, the photonic integrated circuit 402 can include an array of elements 502 up to a size of 1024×1024 (meaning over one million array elements 502) or even larger. The size of the photonic integrated circuit 402 is based, at least in part, on the number and size of the array elements 502. As noted above, in some cases, the photonic integrated circuit 402 can be square with edges of about 40 mm in length. However, the photonic integrated circuit 402 can be scaled to smaller or larger sizes (such as about 2.5 cm by about 2.5 cm), while further scaling up to even larger sizes (such as about 20 cm by about 20 cm or about 30 cm by about 30 cm) can be possible depending on fabrication capabilities.

Each array element 502 can include an antenna element 504, which is configured to physically transmit and/or receive one or more optical signal beams to or from one or more external devices or systems. For example, each antenna element 504 can represent a nanophotonic antenna or other antenna element that transmits or receives at least one optical signal beam, Depending on the implementation, the antenna element 504 can sometimes be referred to as an emitter in a transmitting array or a receiver in a receiving array. Each antenna element 504 can have any suitable size, shape, and dimensions. In some cases, the emitting/receiving surface of the antenna element 504 can be about 2 μm to about 4 μm in diameter.

Each antenna element 504 here is coupled to a signal pathway 506. The signal pathways 506 are configured to transport optical signals to and/or from the antenna elements 504. For example, the signal pathways 506 can provide optical signals to the antenna element 504 for transmission. Additionally or alternatively, the signal pathways 506 can provide optical signals received by the antenna elements 504 to optical detectors or other components for processing. Each signal pathway 506 includes any suitable structure configured to transport optical signals, such as an optical waveguide. Note that only a portion of the signal pathway 506 may be shown in FIG. 4, since a signal pathway 506 can vary based on how the associated array element 502 is designed and positioned within the photonic integrated circuit 402.

A modulator 508 can be provided for each antenna element 504 and can be used (among other things) to control the phases and/or amplitudes of optical signals transmitted or received by the associated antenna element 504. For example, when the antenna elements 504 are transmitting, the modulators 508 can be used to achieve desired phases of outgoing optical signal beams in order to perform beam forming or beam steering. When the antenna elements 504 are receiving, e.g. used as an FPA, the modulators 508 can be used to apply phase control to the incoming wavefront of received optical signals in order to decompose or reconstruct the wavefront. Each modulator 508 can include any suitable structure configured to modulate the phase of an optical signal, such as a resonant micro-ring modulator or a PN junction micro-ring modulator. In some cases, each modulator 508 can be a resonant micro-ring modulator that is about 4-6 μm in diameter, although modulators of other sizes can be used.

The modulators 508 of the photonic integrated circuit 402 can be electrically coupled to a digital read in integrated circuit (DRIIC) layer 510, which is used to provide electrical signals to the modulators 508 in order to control the phase and/or amplitude modulations applied to the incoming or outgoing optical signals by the modulators 508. The (DRIIC) design described herein can be tailored to the unique characteristics of optical phased arrays. Rather than using large break-out circuit boards and digital-to-analog converters, the DRIIC design can have a low profile and support operations such as flip-chip bonding to a photonic integrated circuit. In some cases, the DRIIC design integrates all PIC-related electronic controls into a hybridized or monolithic design. Also, the DRIIC design can support a unit cell architecture, where each DRIIC unit cell corresponds to and interacts with a corresponding PIC unit cell. This supports scalability of the PIC design as well as the DRIIC design to any suitable size. Overall, the DRIIC design helps to support various functions, such as coordinated array phase and amplitude control, in compact packages. The photonic integrated circuit 402 can be bonded to the DRIIC layer 510 using any mechanisms for electrically coupling the photonic integrated circuit PIC 402 and the DRIIC layer 510 can be used.

The DRIIC layer 510 in this example includes a number of individual DRIIC cells 512, where each DRIIC cell 512 can be associated with (and in some cases can have about the same size as) a corresponding one of the array elements 502. The DRIIC cells 512 control the phase modulations that are applied by the modulators 508 of the array elements 502. The DRIIC cells 512 can essentially function as digital-to-analog conversion devices, where digital programming (such as 2-bit, 8-bit, or other digital values) are converted into appropriately-scaled direct current (DC) analog voltages spanning a specific range of voltages. As a particular example, the DRIIC cells 512 can operate to convert digital values into suitable DC analog voltages between 0 V and 3.3 V, although other voltages (including negative voltages) can be supported depending on the implementation.

In this example, each DRIIC cell 512 can include a register 514 configured to store values associated with different phase shifts and/or amplitude changes to be applied by the modulator 508 of a corresponding array element 502. To provide a desired phase shift or amplitude change, appropriate values from the register 514 are selected and provided to two amplifiers 516 and 518, which generate output voltages that are provided to the associated modulator 508. The output voltages control the phase shift provided by the associated modulator 508. Different values from the register 514 are provided to the amplifiers 516 and 518 over time so that different output voltages are applied to the associated modulator 508. In this way, each DRIIC cell 512 can cause its associated modulator 508 to provide different phase shifts over time.

In some embodiments, each DRIIC cell 512 can be used to provide a relatively small number of different output voltages to its associated modulator 508. For example, in some cases, each DRIIC cell 512 can cause the associated modulator 508 to provide four different phase shifts. However, other numbers of output voltages and associated phase shifts can be supported here, such as when up to 256 different phase shifts or more are supported. Also, the output voltages provided to the modulators 508 in different DRIIC cells 512 can be different even when those modulators 508 are providing the same phase shift, which can be due to factors such as manufacturing tolerances. The actual output voltages used for each modulator 508 can be selected during calibration so that appropriate values can be stored in each register 514.

In this example, the actual values in each DRIIC cell 512 that are provided to the amplifiers 516 and 518 by the register 514 over time can be controlled using a demultiplexer 520. Each demultiplexer 520 receives a stream of computed array phase shifts 522 and outputs the phase shifts 522 that are to be applied by that DRIIC cell's associated modulator 508. The phase shifts 522 output by the demultiplexer 520 can identify or otherwise to be used to select specific values from the register 514 to be output to the amplifiers 516 and 518. The computed array phase shifts 522 here can be provided by one or more external components, such as the electronic control board 408 or an external component communicating with the electronic control board 408. While not shown here, array-level deserialization circuitry can be used to separate and fan out high-speed digital signals to the array of individual DRIIC cells 512.

Each register 514 includes any suitable structure configured to store and retrieve values. Each amplifier 516 and 518 includes any suitable structure configured to generate a control voltage or other control signal based on an input. Each demultiplexer 520 includes any suitable structure configured to select and output values.

Note that this represents one example way in which the modulators 508 of the array elements 502 can be controlled. In general, any suitable technique can be used to provide suitable control voltages or other control signals to the modulators 508 for use in controlling the phase shifts and/or amplitude changes provided by the modulators 508. For example, the approach shown in FIG. 4 allows values that are applied to the amplifiers 516 and 518 to be stored in the register 514 and retrieved as needed, which allows an external component to provide indicators of the desired values to be retrieved to the DRIIC cells 512. In other embodiments, an external component can provide digital values that are converted by different circuitry into analog values.

Various electrical connections 524 are provided in or with the DRIIC layer 510. The electrical connections 524 can be used to provide electrical signals to the DRIIC cells 512, such as when the electrical connections 524 are used to receive high-speed digital signals containing the computed array phase shifts 522 for the DRIIC cells 512. Any suitable number and arrangement of electrical connections 524 can be used here. A thermal spreader 526 can be positioned in thermal contact with the DRIIC layer 510 to provide a more consistent temperature across the DRIIC layer 510 and the photonic integrated circuit 402. The thermal spreader 526 can also provide thermal energy to the DRIIC layer 510 to heat the DRIIC layer 510 and the photonic integrated circuit 402 and can help to maintain a substantially constant temperature of the photonic integrated circuit 402. The thermal spreader 526 can be formed from any suitable material(s), such as one or more metals like copper, and in any suitable manner. The thermal spreader 526 can have any suitable size, shape, and dimensions.

Although FIGS. 2-4 illustrate one example of a photonic integrated circuit-based optical device 300, various changes can be made to FIGS. 2-4. For example, one or more photonic integrated circuits can be packaged in any other suitable manner, arranged relative to other components in any other suitable manner, and coupled to other components in any other suitable manner. Also, any other suitable modulation control approach and any other suitable thermal management approach can be used with one or more photonic integrated circuits. For example, the configuration and arrangement of array elements 502, signal pathways 506 (e.g., waveguides), and modulators 508 can be different from what is shown in FIG. 4. An alternate configuration is illustrated in at least FIG. 6.

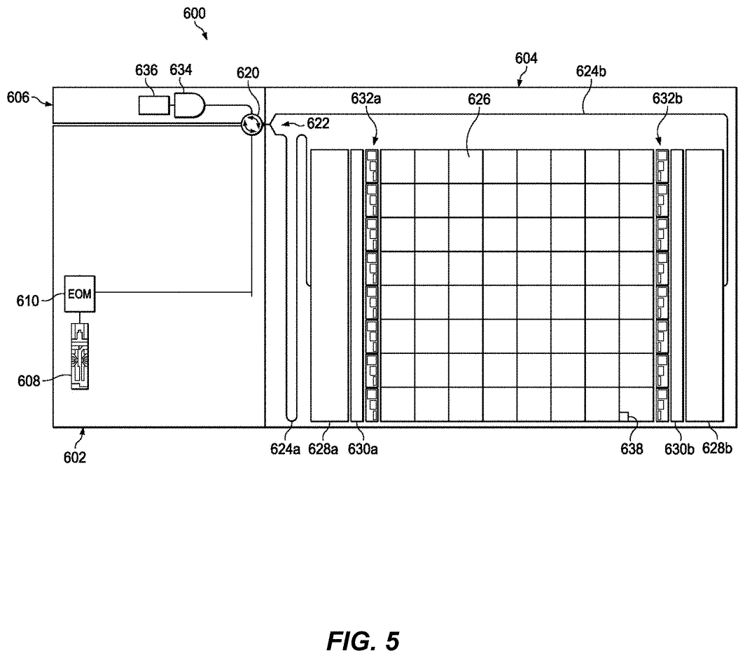

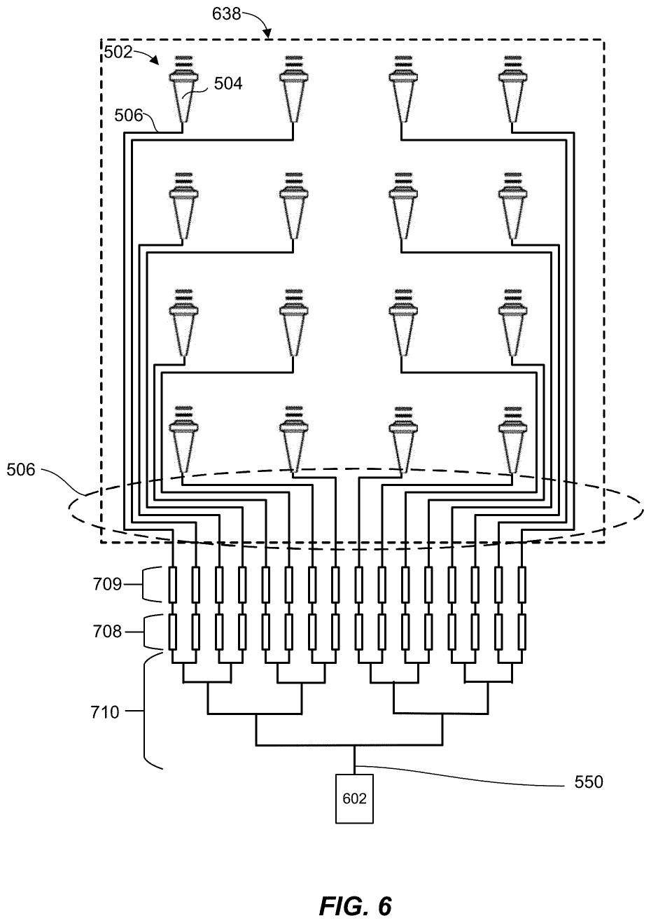

FIGS. 5 and 6 illustrate a more specific example implementation of a photonic integrated circuit-based optical system including the photonic integrated circuit-based optical device 300 of FIGS. 2 through 4 according to this disclosure. In particular, FIGS. 5 and 6 illustrate an example architecture 600 that can be implemented within the optical device 300. As shown in FIG. 5, the architecture 600 can include a source laser 602, an OPA 604, and a receiver 606. The source laser 602 is an electromagnetic radiation source that generally operates to produce optical signals (e.g., electromagnetic radiation) that are provided to and are used by the OPA 604 to transmit outgoing optical signals. The OPA 604 generally operates to transmit outgoing optical signals and to receive incoming optical signals. The receiver 606 generally operates to process the incoming optical signals. These components allow the architecture 600 to support optical transceiver functionality, although some components (e.g., either the source laser 602 or the receiver 606) can be removed from the architecture 600 if only optical transmitter or only optical receiver functionality is desired.

In this example, the source laser 602 can include a laser 608, which operates to produce a lower-power input beam. The laser 608 can include any suitable structure configured to generate a laser output, such as a distributed feedback (DFB) diode laser. The lower-power input beam can have any suitable power level based on the laser 602 being used for a specific application. In some cases, the lower-power input beam can have a power level of one or several tens of milliwatts to one or several hundreds of milliwatts, although these values are for illustration only. Also, in some cases, the laser 602 can be fabricated using at least one group III element and at least one group V element and can therefore be referred to as a “III-V” laser. However, any other suitable materials can be used to fabricate the laser 602. The lower-power input beam optionally may be provided to an electro-optic modulator (EOM) 610, which can modulate the lower-power input beam based on an input electrical signal. The EOM 610 can provide any suitable modulation here, such as when the EOM 610 is implemented as a Mach-Zehnder modulator (MZM) that provides amplitude modulation. The EOM 610 can be optically connected to a circulator 620 through an optical pathway such as a waveguide to convey light beams from EOM 610 to the circulator 620.

In the OPA 604, the laser output from the source laser 602 can be split by a splitter 622 so that substantially equal first portions of the combined signal are provided to two waveguides 624a and 624b. The waveguides 624a and 624b here can have substantially the same length so that there is little or no phase difference between the first portions of the combined signal exiting the waveguides 624a and 624b. In this example, the photonic integrated circuit 402 can be implemented using supercells 626, where each supercell 626 includes a portion of the array elements 502. In some embodiments, for example, each supercell 626 can include a 32×32 arrangement of array elements 502, although other numbers and arrangements of array elements 502 can be used in each supercell 626. In this particular example, the photonic integrated circuit 402 includes sixty-four supercells 626, although other numbers of supercells 626 can be used. Multiple supercells 626 can be driven using the same portion of the combined signal from the source laser 602, which helps to simplify phase control and other operations in the architecture 600. The ability to drive all array elements 502 in a supercell 626 collectively allows, for instance, amplitude modulation of each supercell 626 to control the transmit power of the array elements 502 in that supercell 626.

In order to drive the supercells 626 using the combined signal from the source laser 602, the waveguides 624a and 624b provide the first portions of the combined signal to splitters 628a and 628b, such as 1×8 optical splitters, which split the first portions of the combined signal into more-numerous second portions of the combined signal. Additional splitters 630a and 630b, such as 8×32 splitters, split the second portions of the combined signal into even more-numerous third portions of the combined signal. This results in the creation of sixty-four optical signals, which can be used to drive the supercells 626. Note that this arrangement of 1×8 and 8×32 splitters is merely one example of how the supercells 626 in this specific photonic integrated circuit 402 can be driven. Other approaches can be used to drive a photonic integrated circuit 402, including approaches that use other numbers or arrangements of splitters. The specific approach shown in FIG. 5 is merely one example of how supercells 626 of this specific photonic integrated circuit 402 can be driven.

Time delay paths 632a and 632b are provided between the splitters 630a and 630b and the supercells 626 in order to compensate for different optical path lengths to reach the different supercells 626. For example, assuming that each row of supercells 626 in the photonic integrated circuit 402 is driven using four outputs from the splitter 630a and four outputs from the splitter 630b, without compensation, different outputs from the splitters 630a and 630b would reach different supercells 626 at different times, which can create undesired phase differences and reduce the throughput of the architecture 600. The time delay paths 632a and 632b represent different optical path lengths, such as those produced by spiraled or other optical pathways that delay at least some of the outputs from the splitters 630a and 630b so that the outputs from the splitters 630a and 630b reach all supercells 626 at substantially the same time. For example, the time delay paths 632a and 632b can delay signals to closer supercells 626 by larger amounts and delay signals to farther supercells 626 by smaller or no amounts. The optical signals that are received at the supercells 626 are used by the supercells 626 to produce outgoing optical signals.

The supercells 626 can receive incoming optical signals, which can be transported over the waveguides 624a-624b and through the circulator 620 to the receiver 606. In this example, the receiver 606 can include at least one photodetector 634, such as at least one photodiode that converts the received incoming optical signals into electrical currents. A transimpedance amplifier 636 can convert the electrical currents into electrical voltages, which can then be further processed (such as to recover information contained in the incoming optical signals).

Note that various components of the OPA 604 and the source laser 602 can be fabricated from different materials in order to allow for different optical power levels to be used in the architecture 600. In the OPA 604, the waveguides 624a and 624b and the splitters 628a and 628b can similarly be fabricated using silicon nitride or other materials that support the transport and splitting of the relatively high-power combined beam from the source laser 602. The splitters 630a and 630b can be fabricated using silicon (rather than silicon nitride) or other materials that can split lower-power optical signals (since the optical energy from the source laser 602 has already been split at this point). However, the components of the architecture 600 can be fabricated from any other suitable materials. Also note that various components of the architecture 600 may or may not be fabricated using one or more common materials.

In some embodiments, all of the components in the architecture 600 of FIG. 5 can be implemented in an integrated manner, such as when implemented using a single integrated electrical and photonic chip. As noted above, for example, different components of the architecture 600 can be fabricated using silicon and silicon nitride, which enables fabrication using standard silicon-based processes. When implemented in an integrated manner, the architecture 600 can be implemented using a single photonic integrated circuit chip, and there may be no need for components such as the fiber inputs/outputs 310, fiber mounts 404, and optical fibers 406. However, integration of the components in the architecture 600 is not necessarily required. Thus, for example, the source laser 602 can be implemented off-chip or replaced using a standard erbium-doped fiber amplifier laser or other external laser. As another example, the receiver 606 can be implemented off-chip.

Although FIGS. 5 and 6 illustrate one more specific example implementation of the photonic integrated circuit-based optical device of FIGS. 2-4, various changes can be made to FIGS. 5 and 6. For example, this particular embodiment logically splits the photonic integrated circuit 402 in half by using two waveguides 624a-624b, two sets of splitters 628a-628b, 630a-630b, and two sets of time delay paths 632a-632b. However, the photonic integrated circuit 402 can be logically split into other numbers of portions or not logically split. Also, various components in FIGS. 5 and 6 can be combined, further subdivided, replicated, omitted, or rearranged and additional components can be added according to particular needs.

A portion 638 of one of the supercells 626 is identified in FIG. 5 and shown in greater detail in FIG. 6. As shown in FIG. 6, this portion 638 of the supercell 626 includes a 4×4 arrangement of array elements 502. As can be seen here, the structure of the array elements 502 can be modified as needed or desired from what is shown in FIG. 4. These array elements 502 can each be fed using a single corresponding waveguide 506. Each waveguide 506 can be in optical communication with the source laser 602, and can be configured to receive electromagnetic radiation (e.g., optical signals) from the source laser 602. Each of the array elements 502 and corresponding waveguides 506 can be in communication with a phase modulator 708 and an attenuator 709 to alter phases and/or amplitudes of electromagnetic radiation within the waveguides 506. The phase modulators 708 can operate similar to phase modulators 508 discussed above.

The source laser 602 can supply optical signals and/or electromagnetic radiation to each of the array elements 502 through the waveguides 506. The laser source can supply the optical signals through an electromagnetic radiation inlet 550 of a series of branches in a cascading tree 710 that split the laser beam from the source laser 602 into equal parts to each of the attenuators 709, phase modulators 708, and waveguides 506 of the array elements 502. While the optical routing of branches, waveguides, array elements, phase modulators 708, and attenuators 709 shown in FIG. 6 are one example of an arrangement of an OPA, no limitation on routing or waveguide pattern is intended by this disclosure. The waveguide pattern and optical routing can be any of a H-tree configuration, Manhattan routing, a cascading tree, or any other type of waveguide routing for an optical phased array.

While portion 626 of supercell 626 shows a 4×4 arrangement of array elements 502, it will be appreciated that other numbers and arrangements of array elements 502 are also possible, such as, for example, 8×8, 16×16, 32×32 and others. Note that if each supercell 626 includes a 32×32 arrangement of array elements 502, each supercell 626 would include thirty-two rows of array elements 502, where each row includes thirty-two array elements 502. Thus, the portion 638 shown in FIG. 6 would be replicated sixty four times within each supercell 626. However, it is possible for the supercells 626 to each have a different number and arrangement of array elements 502 as needed or desired.

In FIG. 6, it can be seen that different path lengths (e.g., waveguide 506 lengths) exist between each of the array elements. In this particular example, the shortest path lengths (e.g., waveguide 506 lengths) exist for the two bottom array elements disposed near the center of the portion 638. The longest path lengths exist for the two top array elements disposed nearest the center of the portion 638. As with the supercells 626 themselves, without compensation, these different path lengths would cause different portions of an optical signal to reach the array elements 502 at different times. In some cases, the phase shifts and/or amplitude changes provided by the modulators 508 in the array elements 502 can be used to compensate for the different path lengths between the input of the main waveguide 702 and each array element 502. Additionally or alternatively, linear or other phase modulators can be used to compensate for the different path lengths between the input 701 of the main waveguide 702 and each array element 502.

As shown in FIG. 6, each of the array elements 502 of the portion 638 of the OPA 604 can be spaced at regular locations from each other to form an array of equally spaced array elements 502 in both X and Y directions of the OPA 604. However, it is to be understood that the arrangement and spacing of the array elements 502 in FIG. 6 is a single example, and that any other spacing and/or arrangement of the array elements 502 are intended to be within the scope of this disclosure without limitation.

### Photonic Ising Computing Engine Architecture

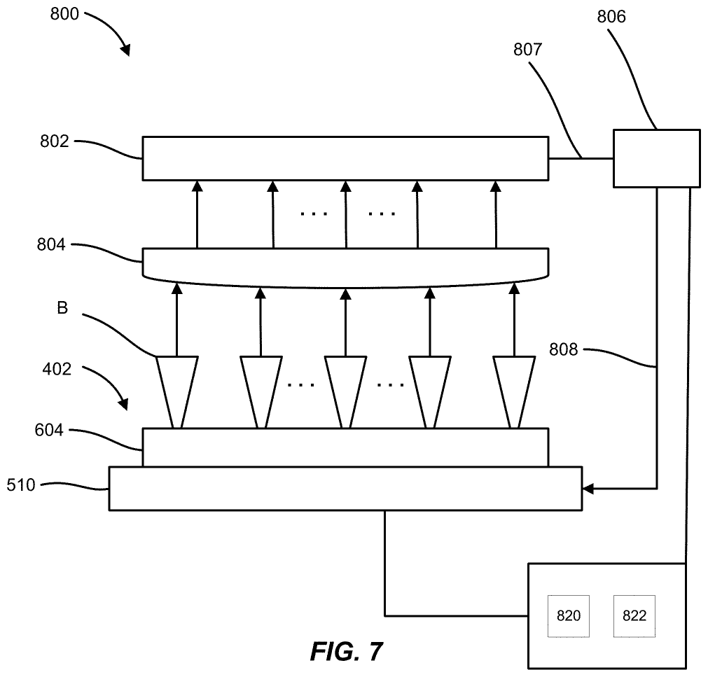

The optical device 300 described above, including the photonic integrated circuit 402 having the optical phased array (OPA) 604, can be used in a scale-able compact photonic and electronic architecture that can be implemented as a photonic Ising computing engine. An exemplar photonic processor computing engine 800 is illustrated in FIG. 7.

As illustrated in FIG. 7, The computing engine 800 can include a photonic integrated circuit 402 having the architecture 600 shown in FIG. 5. The photonic integrated circuit 402 can include an optical phased array (e.g., optical phased array (OPA) 604) and an electronic layer (e.g., DRIIC layer 510 as described above). The DRIIC layer 510 can include CMOS or other electronic circuits that control and calibrate phases and amplitudes, as well as other characteristics, of beams emitted from the array elements of the optical phased array 604. The OPA 604 and the controlling electronics (e.g., the DRIIC layer 510) can be programmed to operate such that the array elements (e.g., radiating pixels) of the OPA 604 radiate optical signal beams B to free space. The optical signal beams B can pass through an optic element 804 (e.g., lens, lens array, lens assembly, prism, or any other optical element) comprising one or more lenses disposed between the photonic integrated circuit (PIC) 402 and the focal plane array (FPA) 802 to project the optical signal beams from the radiating pixels onto the focal plane array (FPA) 802.

The beams passing through the optic element 804 can then travel to the focal plane array (FPA) 802, which can comprise an image sensor that receives the optical beams B. The focal plane array can consist of an OPA operating in receive mode, or can consist of a spatial light modulator and detector, or can consist of an imaging device such as a charge-coupled device (CCD) or CMOS imager, commonly found at the focal plane of commercial and industrial cameras. The focal plane array 802 receives the beams and outputs data signals indicating an intensity level registered by the by the FPA 802 from the OPA 604. The calculated intensity at the FPA 802 plane due to optical interference of the radiating optical signal beams B from the OPA 604 is correlated (or proportional) to the Ising Hamiltonian energy of the Ising spin glass matrix for the particular Ising model problem. The Ising spin glass matrix is a set of phase values imposed on the array elements 502 (e.g., radiating pixels) as an initial condition for solving the Ising model.

The output data signals from the FPA 802 can be sent over an electronic feedback circuit. The electronic feedback circuit can comprise a communication pathway 807 (e.g., wireless or wired communication) between the FPA 802 and digital electronics 806. The electronic feedback circuit can further comprise the digital electronics 806 that can include a processor, a memory, and instructions stored on the memory that are executed by the processor. The digital electronics 806 can process the output data signals from the FPA 802 to calculate a Hamiltonian energy state for the Ising spin glass matrix encoded as phases to the array elements 502. The electronic feedback circuit can then produce a feedback signal that is sent to the OPA control electronics (e.g. DRIIC layer 510) over signal pathway 808 (e.g., wired or wireless pathways) of the electronic feedback circuit to recalibrate and control the array elements of the OPA 604 based on the feedback signal and energy Hamiltonian to move the OPA 604 and emitted optical signal beams B closer to a ground state energy of the Ising spin glass matrix of an Ising model. The process (e.g., emit optical signal beams B, output from the FPA 802 signals indicating intensities of the optical signal beams B, process signals from the FPA 802 in the digital electronics 806, and send a feedback signal to the DRIIC layer based on the intensities) can be re-executed iteratively until the ground state Hamiltonian energy for the Ising spin glass matrix encoded on the array elements 502 is achieved and a solution is calculated by retrieving the phases/amplitudes of each radiating pixel or array element 502 using a phase retrieval algorithm at the ground state Hamiltonian energy.

As illustrated in FIG. 7, each of the digital electronics 806 (e.g., electronic feedback circuit) and DRIIC layer 510 (e.g., electronic control circuit) can be in communication with one or more processors 820 and one or more non-transitory computer readable storage media 822 operable with the processors 820 that respectively execute and store instructions for operation of the engine 800. The processors can be on-board the digital electronics 806 and DRIIC layer 510 or can be disposed remotely from the digital electronics 806 and DRIIC layer 510. Also, it will be appreciated that each of digital electronics 806 and DRIIC layer 510 may include their own separate processors and storage media.

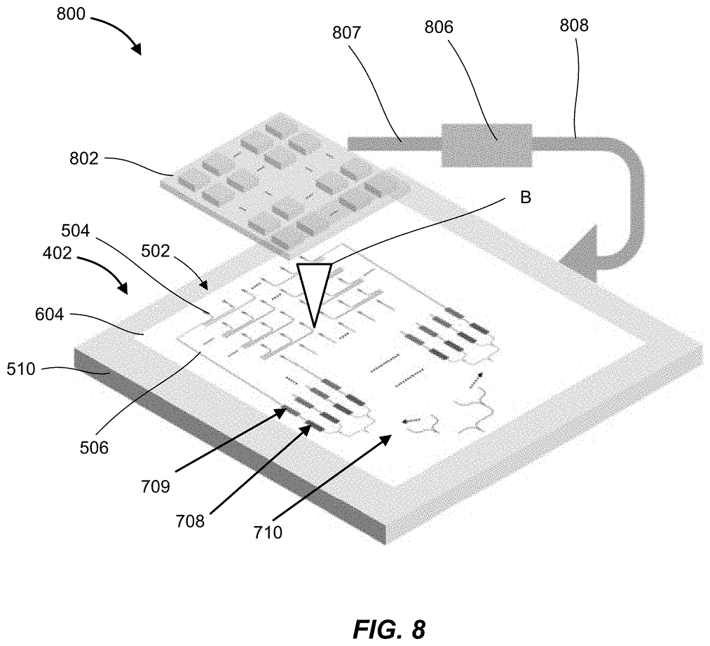

FIG. 8 shows an alternate view of the computing engine 800. In FIG. 8, the computing engine 800 is illustrated as including an optical phased array similar to that shown in FIG. 6. It will be appreciated that the number of array elements 502 is not limited to the number shown in either FIG. 6 or FIG. 8; and that indeed any number of array elements can be included in the OPA 604. The photonic integrated circuit 402 and OPA 604 can be used for analog computing and in particular calculation of the Ising Hamiltonian energy for an Ising spin glass matrix. In FIG. 7, laser light from a laser source 602, after being coupled to the photonic integrated circuit 402, is split into many branches in via a cascaded binary tree division architecture 710 shown in FIG. 6 and FIG. 8. Laser light in each waveguide branch then goes through individual phase modulators 708 and attenuators 709 to adjust the phase and amplitude of light for each branch. Following this, the light of each branch travels to reach to a 2D array of optical antennas 504 (e.g., array elements 502 or, in other words, radiating pixels), with each branch corresponding to one array element 502. The radiating pixels (e.g., array elements 502) emit optical signal beams B which after traveling through free space and, optionally, a lens optic element 802 (not shown in FIG. 8), reach the FPA 802. The interference of all of the emitted optical signal beams B at the FPA plane and the measured intensity at the FPA 802 have an analytical mathematical expression correlated to the Hamiltonian energy of an Ising spin glass matrix of an Ising model. The equivalence between the measured intensity of optical signal beams at the FPA plane and the Ising model has been shown in experiments employing spatial light modulators (SLM) to solve Ising models. The measured intensity at the FPA 802 in FIG. 8 can be processed in the digital electronics 806, and an appropriate feedback signal can be provided to the DRIIC layer 510 and the photonic optical phased array 604 for re-programming the phases (and, optionally, the amplitudes) of each array element 502. This process can be iterated to result in the lowest-energy state of the Ising Hamiltonian for an Ising spin glass matrix which is encoded in the radiating pixel intensity map of the PIC-OPA computing engine 800.

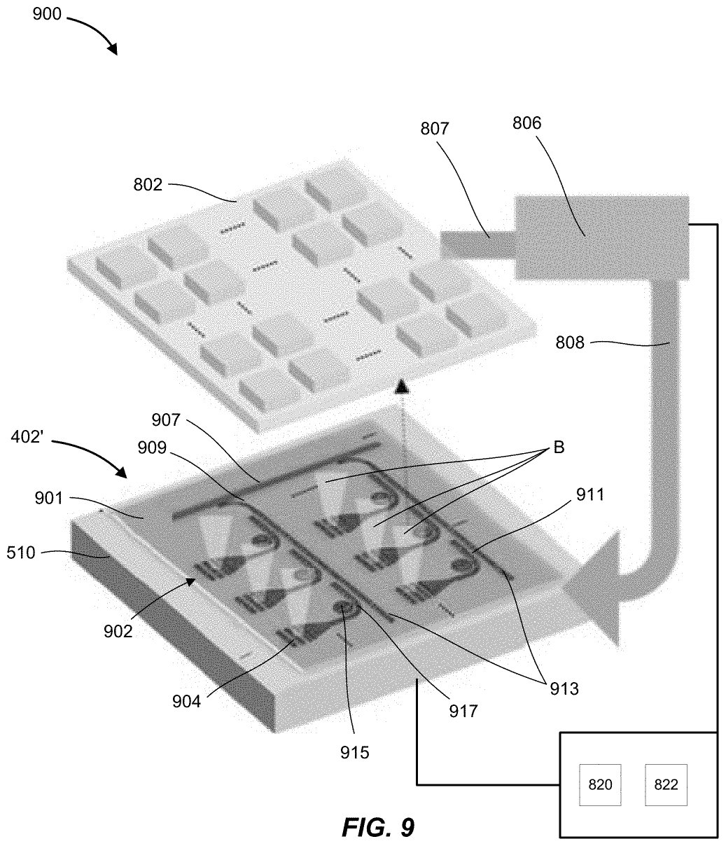

An alternative architecture photonic processor computing engine 900 is illustrated in FIG. 9. Elements in engine 900 that are similar to elements in engine 800 are identified with the same identifying numbers. In FIG. 9, the computing engine 900 is illustrated as including an alternate optical phased array 901 from what is shown in FIG. 6. For example, the OPA 901 can include amplitude and phase control that is local to each of the array elements 902.

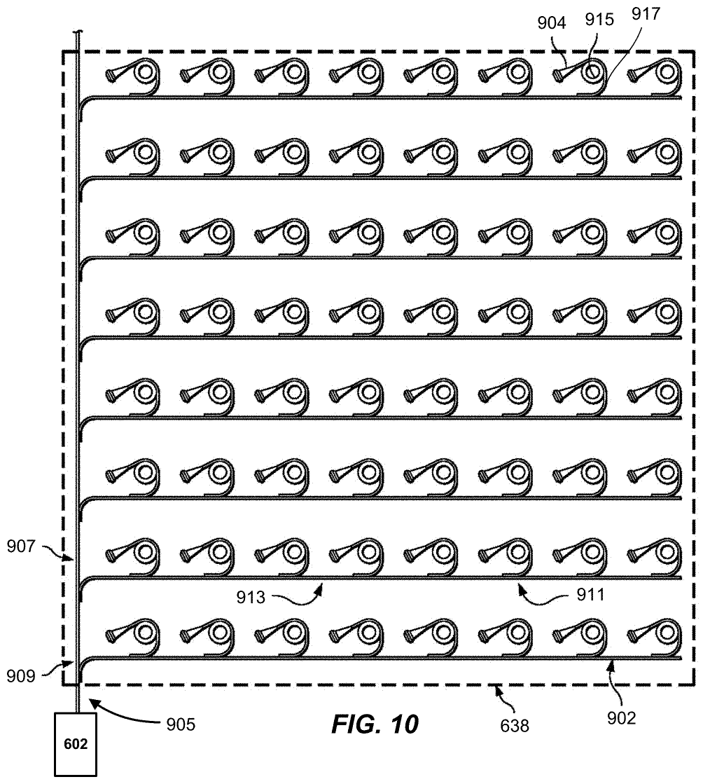

With reference to FIG. 10, the alternative OPA 901 is illustrated showing positioning and configuration of array elements 902 within the OPA 901. As shown in FIG. 10, the array elements 902 can each include an antenna element 904 and a phase/amplitude modulator 915. Each modulator 915 can include any suitable structure configured to modulate the phase of an optical signal, such as a resonant micro-ring modulator or a PN junction micro-ring modulator. In some cases, each modulator 508 can be a resonant micro-ring modulator that is about 4-6 μm in diameter, although modulators of other sizes can be used. The on-chip electronic control circuit (e.g., DRIIC layer 510) can be configured to apply voltages to each of the optical phase modulators 915 to modulate the optical signal beams within a segment 917 of the waveguide in communication with the optical antenna 904.

Each of the array elements 902 can be fed using a waveguide comprising one or more separate waveguides. As illustrated, the waveguide can include main waveguide 907. The main waveguide 907 can be in optical communication with the source laser 602, and can be configured to receive electromagnetic radiation (e.g., optical signals) from the source laser 602. Splitters 909 can be positioned along the main waveguide 907 to split off portions of an optical signal propagating in the main waveguide 907. These portions of the optical signals split off of the main waveguide 907 are provided over branch waveguides 913 that are optically coupled to the main waveguide 907 at a plurality of different locations from each other along the main waveguide 907, being coupled to the main waveguide 907 by the splitters 909. Splitters 911 can be positioned along the branch waveguides 913 to further split off portions of the optical signal in the respective branch waveguides 913. Ideally, the splitters 909 and 911 are configured such that each of the array elements 902 receives a substantially equal portion of the optical signal input to the main waveguide 907. In some embodiments, the main waveguide 907, the branch waveguides 913, and the splitters 909 and 911 can be formed from silicon, although other materials can be used.

Note that if each supercell 626 includes a 32×32 arrangement of array elements 902, each supercell 626 would include thirty-two rows of array elements 902, where each row includes thirty-two array elements 902. Thus, the portion 638 shown in FIG. 6 would be replicated sixteen times within each supercell 626. However, it is possible for the supercells 626 to each have a different number and arrangement of array elements 902 as needed or desired.

In FIG. 10, it can be seen that different path lengths exist between the input of the main waveguide 907 (located at the bottom of the main waveguide 907 in FIG. 10) and different array elements 902. In this particular example, the shortest path length exists between the input of the main waveguide 907 and the bottom left array element 902, and the longest path length exists between the input of the main waveguide 907 and the top right array element 902. As with the supercells 626 themselves, without compensation, these different path lengths would cause different portions of an optical signal to reach the array elements 902 at different times. In some cases, the phase shifts provided by the modulators 915 in the array elements 902 can be used to compensate for the different path lengths between the input of the main waveguide 907 and each array element 902. Additionally or alternatively, linear or other phase modulators can be used to compensate for the different path lengths between the input of the main waveguide 902 and each array element 902.

It is to be appreciated that the OPA 901 can be disposed in portion 638 shown in architecture 600 of FIG. 5. It should further be understood that the number of array elements 902 is not limited to the number shown in either FIG. 9 or FIG. 10; indeed, any number of array elements can be included in the OPA 901. Now with returning reference to FIG. 9, the photonic integrated circuit 402′ and OPA 901 can be used for analog computing and in particular calculation of the Ising energy Hamiltonian of an Ising spin glass matrix. In FIG. 9, laser light from a laser source 602, after being coupled to the photonic integrated circuit 402′, is split into many branch waveguides 913 from a main waveguide 907 via splitters 909 shown in FIG. 9 and FIG. 10. Then laser light in each branch waveguide 913 is split by splitters 911 into segments 917. The light then goes through individual phase/amplitude modulators 915 to adjust the phase and/or amplitude of light for each segment 911. The light of each segment 917 then travels to reach to a 2D array of optical antennas 904 (e.g., array elements 904 or, in other words, radiating pixels), with each segment 917 corresponding to one array element 902. The radiating pixels (e.g., array elements 902) emit optical signal beams B which after traveling through free space and a lens optic element 802 (not shown in FIG. 8), reach the FPA 802. The interference of all of the emitted optical signal beams B at the FPA plane and the measured intensity at the FPA 802 have an analytical mathematical expression correlated to the Hamiltonian energy for an Ising spin glass matrix. The equivalence between the measured intensity of light at the FPA plane and the Ising spin glass matrix has been shown in experiments employing spatial light modulators (SLM) to solve Ising models. The measured intensity at the FPA 802 in FIG. 8 can be processed in the digital electronics 806, and an appropriate feedback signal can be provided to the DRIIC layer 510 and the photonic phased array 901 for re-programming the phases (and, optionally, the amplitudes) of each array element 902. This process can be iterated to result in the lowest-energy state of the Ising Hamiltonian for the Ising spin glass matrix which is encoded in the radiating pixel intensity map of the PIC-OPA computing engine 900.

As illustrated in FIG. 9, each of the digital electronics 806 (e.g., electronic feedback circuit) and DRIIC layer 510 (e.g., electronic control circuit) can be in communication with one or more processors 820 and one or more non-transitory computer readable storage media 822 that respectively execute and store instructions for operation of the engine 800. The processors can be on-board the digital electronics 806 and DRIIC layer 510 or can be disposed remotely from the digital electronics 806 and DRIIC layer 510. Also, it will be appreciated that each of digital electronics 806 and DRIIC layer 510 may include their own separate processors and storage media.

The alternative computing engine 900 presents several additional advantages over the current art. For example, the computing engine 900 moves the phase and amplitude control to be local to the radiating pixel, forming a replicable unit cell. Using this unit cell approach facilitates scale up to larger numbers of problem variables, as represented by Ising Spins and/or Ising Spin Glass matrix elements. Since concatenating multiple SLM-based devices is topologically difficult, and scale-up is therefore limited for alternate approaches, the scalability of the unit cell and computing engine 900 allows for an Ising-solving computing engine that can be scaled to any desirable size for a particular application. This gives a user many more options for architectures and designs for solving Ising models and allows the designs to be incorporated into many more applications and platforms. While breaking the problem into sub-problems for separate SLMs and separately solving the separate problems is a possible approach for SLM Ising solvers, this has shown not to provide the desired (ground state) solution for many interconnected analog problem formulations.

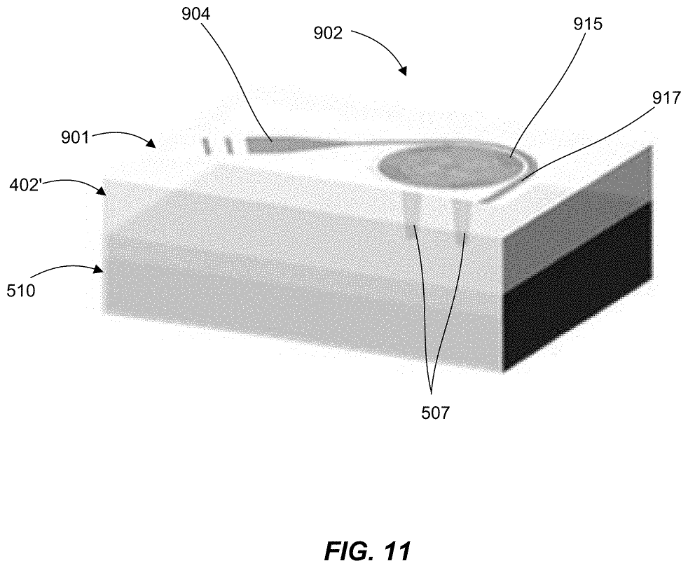

To scale the phased array architecture shown in FIG. 9 to a large number of array elements 902 (e.g., representing problem variables represented by Ising spins and/or Ising spin glass matrix elements), the phase/amplitude modulators 915 will be controlled by a CMOS circuitry layer (e.g., DRIIC layer 510) under the photonic layer comprising OPA 901. This is shown in more detail in FIG. 11, wherein the photonic layer containing the OPA 901, array elements 902, and antennas 904 is bonded to the electronic layer 510. The electronic layer 510 can comprise the electronic control circuit (e.g., DRIIC layer 510) disposed on a surface of the photonic layer, the electronic control circuit comprising a digital read-in integrated circuit (DRIIC) board in electrical communication with each of the optical phase modulators of the radiating pixels. The electronic control circuit (e.g., DRIIC layer 510) can be configured to apply voltages to control each of the optical phase modulators

Metal vias 507 through the bonding layers connect CMOS electronics of the DRIIC layer 510 to contact electrodes of the phase/amplitude modulators 915 in the photonic layer. Disposing the controlling electronics of the DRIIC layer 510 in a different layer than the OPA 901 allows for electronic routing and wiring to be on a different layer than the optical routing (e.g., waveguides). This can provide additional space for scaling to more array elements and larger sized arrays. Additionally, no interference between intersecting optical and electrical wiring is caused due to the electrical and optical routing being disposed in different layers.

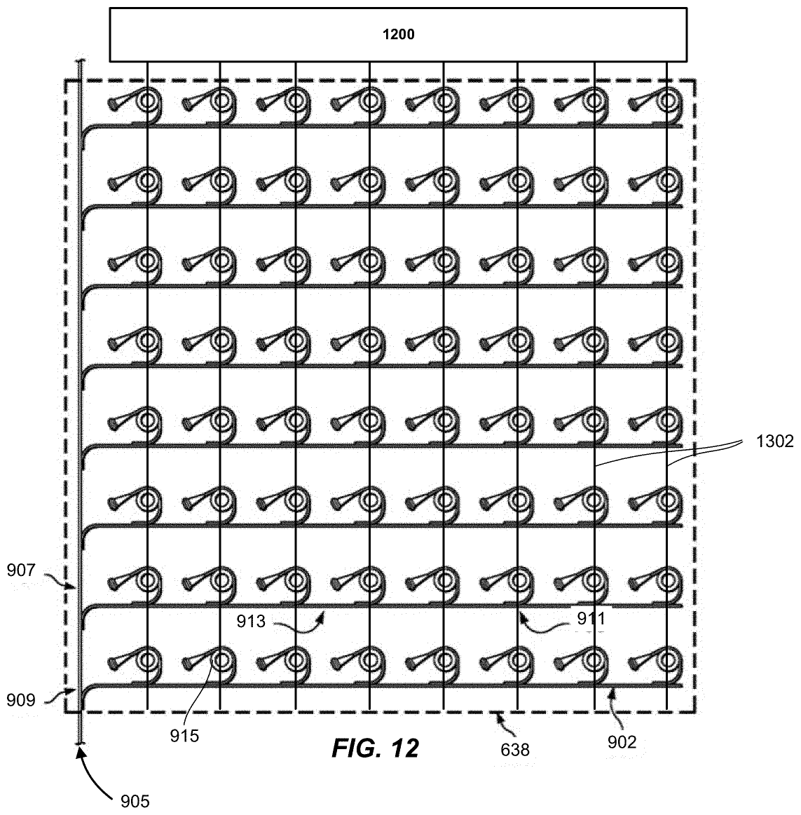

It is to be understood that the electrical wiring and optical routing waveguides do not need to be in different layers but can be formed on the same chip when the number of array elements in an OPA is below a certain number. If the number of the array elements in the optical phased array is not quite large (e.g., 16×16 or below), then an OPA can still have area to accommodate electric wiring and optical routing on the same optical chip without suffering from circuit topology limitations. For example, in FIG. 12, an example of an 8×8 optical phased array is shown wherein both optical routing (e.g., waveguide 905) and electric routing (e.g., wires 1302) are on the same photonic chip. DRIIC electronics 1200 can be connected to each of the wires 1302 and each of the wires can be connected to the modulators 915 to apply voltages to the modulators 915 to control amplitude and phase of each array element 902. In this approach, the optical routing is disposed at a different height within the photonic integrated circuit chip than the metal routing to prevent crossing metal wiring lines with optical lines. In contrast to the configuration shown in FIG. 11, the example of FIG. 12 cannot be scaled to larger arrays or arrays having large numbers of array elements (e.g., 32×32). However, moderate size arrays (e.g. 16×16) placing optical routing and electrical wiring on the same chip will not overly burden the available space the chip.

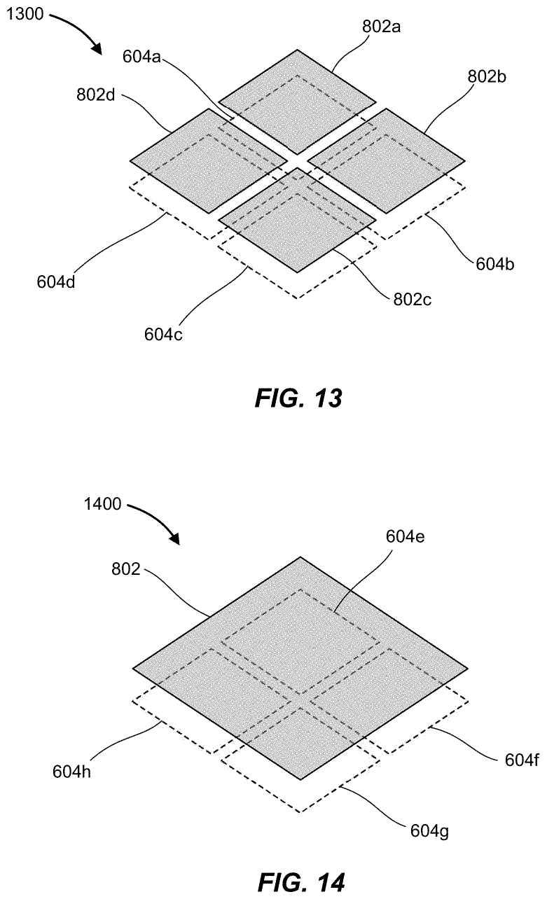

More advanced architectures for solving larger scale Ising problems with reduced hardware complexity are possible with the PIC-OPA configuration illustrated in FIG. 7. For example, tiling of multiple PIC-OPA computing engines can be carried out to solve larger problem sizes. In FIG. 13, a compact computing system 1300 is illustrated, which is a multicore analog processor showing four optical phased arrays 604a, 604b, 604c, and 604d according to the principles described herein, (e.g., 402 in FIG. 7). In the multicore analog processor of system 1300, the four OPAs 604a-604d each face one corresponding focal plane array 802a, 802b, 802c, or 802d. In this configuration, larger scale Ising model problems can be solved by breaking the problem into four parallel sub-problems. Solved by each of the computing engines including the OPAs 604a, 604b, 604c, and 604d and their corresponding FPAs 802a, 802b, 802c, or 802d according to the principles described in this disclosure.

FIG. 14 illustrates an alternate computing system 1400. System 1400 is a single core analog processor in which four optical phased arrays 604e, 604f, 604g, and 604h are facing a single FPA camera 802. In computing system 1400, the hardware complexity of the optical phased arrays 604e, 604f, 604g, and 604h in terms of electronics and optics is much lower because of the scalability of the optical phased arrays. Scalability of each of the PIC-OPAs shown in FIG. 13 also allows for breaking down a PIC-OPA (e.g., 604a) into sub-blocks 604e, 604f, 604g, and 604h, as shown in FIG. 14. The computing system 1400 allows for solving larger scale Ising model problems with all interactions represented, but with the optical phased arrays broken down into sub-blocks 604e, 604f, 604g, and 604h to facilitate manufacturing processes and to avoid the problems of limited space for optical and electrical routing. The scalability means that the electronic wiring to reach phase modulators as well as optical routing to deliver laser light to each optical antennas have less issues of circuit topology and electronic or optical wiring/routing crosstalk. While Ising Hamiltonian calculation for an Ising spin glass matrix is traditionally performed with subarrays, a single calculation plane (e.g., single FPA 802) has performance advantages over the multiple FPAs of FIG. 13. For example, calculations are more accurate when all-to-all coupling can be achieved, and any discontinuity or parallelization into subarrays of the array contributes to a reduction in overall performance by adding a break in the all-to-all coupling. Therefore, as the problem complexity increases, a single uninterrupted FPA with continuous sensing elements will render better overall performance than a segmented one. Discontinuities on the transmitted side have less effect on performance because the sensed wavefront at the FPA is not sensitive to lateral position of the source and couples all the sources from multiple OPAs at each position of the FPA, therefore providing greater performance with system 1400 than system 1300.

Accordingly, the novel architecture of FIG. 7, especially in the configuration shown in FIG. 14, facilitates solving of NP-hard problems using Ising models with a significantly increased number of Ising spin states than are possible in alternate approaches (e.g., SLMs). Specifically, the optical and electrical wiring shown in FIG. 11 illustrates how the optical phased arrays 604a-604h increase capacity of problem sizes being solved by allowing more array elements to be placed on the circuit without complicating optical and electrical routing. Allowing more array elements (e.g., more Ising variables in an Ising spin glass matrix) in smaller sized arrays without complicating wiring and routing allows Ising model problems to be solved at speeds significantly higher than speeds for solving similar problem sizes using alternate approaches and architectures (e.g., SLMs), while still maintaining low size, weight, and power of the hardware implementation. Solving the Ising model with the novel architectures of computing engines described herein will be described in further detail below.

Solving Ising Models with the Disclosed Computing Engines

As recited previously, NP-hard optimization problems are of interest to many fields including finance, economics, cryptography, medicine, biology, and other scientific and societal applications. However, solutions to such problems cannot be guaranteed to be found, i.e. are not deterministic, in polynomial time. As is understood in computational complexity theory, NP-hard combinatorial optimization problems can be mapped to Ising Hamiltonian models (e.g., an Ising spin glass matrix) and/or XY Hamiltonian models for efficient solving of the NP-hard problems. Non-traditional processors, such as the computing engines described herein, can harness properties (e.g., far-field intensity, phase, amplitude, and interference patterns of emitted optical signal beams) unique to the physical systems of implementation to realize lower resource-consuming algorithms which cannot be implemented on conventional processors. Processors which have been used to solve Ising model problems have instead included quantum annealers, gate-based quantum computers, trapped ions, coherent Ising machines, stochastic nanomagnets, and spatial light modulators. However, such traditional methods for solving such problems require resources (e.g., processors, computing power, time) which grow exponentially with problem size.

The computing engine 800 described herein utilizes a different architecture and different type of engine/processing element to solve NP-hard problems. The current disclosure describes a photonic integrated circuit with an optical phased array (e.g., PIC-OPA as shown in engines 800 and 900) used for solving NP-hard problems mapped to Ising models (e.g., Ising spin glass matrix). The PIC-OPA computing engine 800 can include a uniform array of antennas spaced at uniform distances, such as is shown in FIG. 6. The array elements 502 can each correspond to a tunable phase modulator 708 that can be used to form optical beams and optical patterns in the far field to solve an all-to-all coupled Ising model. An all-to-all coupled Ising model is an Ising model in which every spin (e.g., phase value of array elements 502 in an Ising spin glass matrix) is coupled to every other spin in an array of spins. In other words, each phase value of each individual antenna is coupled to (e.g., affected by) all of the other phases of all of the other array elements 502 in the OPA 604, 901.

Photonic Ising solvers such as the computing engine architectures described herein provide advantages over other Ising solving methods including the ability to encode Ising spins of an Ising spin glass matrix in optical phases of optical signal beams emitted from optical antennas, easy reconfiguration of such phases, and more compact, less complex, and less costly infrastructures than those that are used for cold atom or ion-based Ising solvers. Photonic Ising machines can further simulate all-to-all coupled Ising models, even for very large numbers of spins, which is not possible for alternative solvers. When compared to photonic spatial light modulators used to solve large scale Ising model problems, the PIC-OPA arrangement described herein (e.g., engines 800 and 900) offers more compact size and higher speed control of on-chip beam emission. Therefore, the system and computing engine 800 described herein provide promise as more compact and more efficient solvers of NP-hard problems than current methods and architectures.

Some methods of solving Ising models use spatial light modulators (SLMs) to find the solution. However, because spatial light modulators can be bulky and slow, the present disclosure uses a PIC-OPA engine 800 to solve the Ising model. The PIC-OPA is more compact than SLMs and programming is significantly faster for the PIC-OPA (e.g., ˜100 kHz-1 MHz) than a conventional SLM (˜1 kHz). Additionally, the bulky SLMs also require using two SLMs in series to solve the Ising model, therefore adding more bulk to the system. Furthermore, using two SLMs in series further requires maintaining precise free-space alignment between both SLMs as well as the FPA to accomplish phase and amplitude modulation separately. The photonic processor computing engine devices described herein allow for more reliable and more compact solving of Ising model problems and do not require precise alignment between the OPA and the FPA.

In photonic processor computing engines 800 and 900 described herein, the propagation of optical signal beams from the near field (directly emitted from the device) to the far field (far enough from the point of optical signal beams emission such that energy from the optical signal beams is proportional to the inverse distance squared) is used for the Ising Hamiltonian energy calculation of an Ising spin glass matrix. Optical phased arrays (OPAs) of the computing engines 800 and 900 include arrays of antennas (e.g., 504 and 904) with corresponding tunable phase-shifters (e.g., 708 and 915) which emit optical signal beams that can form beams or patterns in the far field. The OPAs can be used to encode and solve Ising and XY models to obtain solutions for NP-hard problems. The Ising Hamiltonian energy H of an Ising spin glass matrix can be proportional to:

$$H = - {\sum }_{< i , j >} {e}_{ij} {Z}_{i} {Z}_{j}$$

where <i, j> denotes all nodes i and j connected by an edge, eᵢⱼ are edge weights. An OPA with an array of antennas (e.g., 504), each with independent phases constrained to either 0 or π (which are equivalent to spin values of 1 and −1 in the Ising model) can be mapped to an Ising spin glass matrix of Ising spins in the OPA 604. In the far field, the expected interference pattern produced from optical signal beams emitted by a uniform array (e.g., OPA) with different phases set at each antenna (e.g., 504) can be calculated. The interference terms between each antenna or spin gives the couplings or edge weights eᵢⱼ, while the total far field image brightness or intensity, when normalized, correlates with the energy of the Ising Hamiltonian of Ising spin glass matrix encoded in the phases of the antennas 504/array elements 502.

Photonic computing engines 800 and 900 with OPAs can also be used to encode and solve XY model problems. The XY model is the continuous phase counterpart of the Ising model, and the spin-spin interaction portion is proportional to:

$$H = - {\sum }_{< i , j >} {e}_{ij} cos ( {θ}_{i} - {θ}_{j} )$$

where <i, j> denotes all nodes i and j connected by an edge, eᵢⱼ are edge weights, and Θ is constrained to any value between [−π, π]. As in the Ising model case, the summed pixel brightness of the far field interference pattern emitted from an OPA with an array of antennas is equal to the energy of the XY Hamiltonian. However, to model an XY Hamiltonian, the phases of the OPA antennas are no longer confined to be either 0 or π, but instead can take any value between [−π, π].

With reference to FIGS. 6-8, an example of solving the Ising model with the computing engine 800 is described below. It will be appreciated that while engine 800 is used as an example, computing engines that use any of the principles described herein can be used to solve the Ising model or an XY Hamiltonian model. To solve the Ising or XY model using the computing engine 800, laser light from the laser source 602 is routed into the OPA 604 through the branches 710. A phase/amplitude can be shifted for the light by phase modulators 708 and attenuators 709. The phase/amplitude can be individually and independently controlled for of each of the optical signal beams from the plurality of radiating pixels (e.g., array elements 502) to represent an Ising Spin Glass matrix of the Ising Spin Model mapped to the radiating pixels. The phases of the light induced by the phase modulators 708 can be representative of spin values in an Ising spin glass matrix. Therefore, the array of array elements 502 emitting the phased light can be seen as an Ising spin glass matrix comprising an array or matrix of spin values positioned relative to each other in the OPA. The spin values/phases representing the values in an Ising spin glass matrix can represent an NP-hard problem or computationally hard/intensive problem modeled using the Ising model and mapped as Ising spin glass matrix to the array elements 502 of the OPA 604.

The light travels to the antennas 504 through waveguides 506 and the antennas 504 emit the optical signal beams toward the focal plane array 802. The resulting emission pattern in the far field is imaged at the focal plane array 802. To find the Hamiltonian energy associated with a given configuration of spins (phases of optical signal beams emitted from the antennas 504), the brightness/intensity of the far field pattern is calculated by summing the pixel brightness in a periodic portion of the far field pattern at the focal plane array 802. The number of pixels in the focal plane array 802 does not bear a 1 to 1 relationship with the radiating pixels (e.g., antennas 504 or array elements 502) of the OPA 604, and in fact can be significantly fewer in number than the radiating pixels of the OPA 604. The calculation of the intensity can be done by the digital electronics 806 of the electronic feedback circuit electronically connected to the focal plane array 802. The electronic feedback circuit can be programmed to provide the feedback signal of the measured intensity by the focal plane array (FPA) to the electronic control circuit. The digital electronics 806 can include a non-transitory computer readable storage medium and a processor that executes instructions stored on the storage medium to calculate the Hamiltonian energy based on the pixel intensity observed in the far-field pattern at the focal plane array 802. The digital electronics can then provide a feedback signal based on the Hamiltonian energy to the DRIIC layer 510 to adjust the phases of the optical signal beams B from the antennas 502. The electronic control circuit (e.g., DRIIC layer 510) can be programmed to process the feedback signal from the electronic feedback circuit to adjust the setting of each of the optical phase modulators of the plurality of radiating pixels to the ground energy state of the Ising spin glass matrix mapped to the radiating pixels. After the phases are adjusted based on the feed back signal, the antennas 504 can again emit optical signal beams to the focal plane array 802, the focal plane array can output signals indicating intensity of the far field pattern to the digital electronics 806, and the digital electronics 806 can process the intensity of the far field pattern to provide another feedback signal to the DRIIC layer 510 for adjusting the phases of the antennas. This process can be repeated iteratively until the OPA arrives at the ground state energy for the encoded Ising problem.

The iteration can be carried out as a genetic algorithm. For example, the initial phases for each antenna 504 can be set at a desired starting point or initial condition as an Ising spin glass matrix. The genetic algorithm can be used adjust the voltages applied to each phase modulator 708 and the phases of each of the optical signal beams emitted from the antennas 504 to reduce far field brightness to iteratively solve for the ground state or minimum energy level of the Ising model. Once the ground state energy level is found for the Ising model, the phases of each of the antennas 504 in the OPA can be retrieved using a Gerchberg-Saxton phase retrieval algorithm, using the constraint of a uniform array structure in the near field and using images of the far field interference pattern as the far field constraint. It is to be understood that any suitable phase retrieval algorithm can be used to retrieve the phase values of each radiating pixel at the ground state energy level to determine the solution for the Ising model mapped to the radiating pixels as an Ising spin glass matrix. The final phase values associated with the radiating pixels (e.g., array elements 502) of the OPA 604 at the ground state energy level of the Ising model represent the solution for the NP hard problem mapped to the OPA as the Ising spin glass matrix.

With reference to FIGS. 6-8, an example of solving the XY model with the computing engine 800 is described below. It will be appreciated that while engine 800 is used as an example, computing engines that use any of the principles described herein can be used to solve the Ising model or an XY Hamiltonian model. To solve the XY model using the computing engine 800, laser light from the laser source 602 is routed into the OPA 604 through the branches 710. A phase/amplitude can be shifted for the light by phase modulators 708 and attenuators 709. The phase/amplitude can be individually and independently controlled for of each of the optical signal beams from the plurality of radiating pixels (e.g., array elements 502) to represent an Ising spin glass matrix of the Ising Spin Model mapped to the radiating pixels. The phases of the light induced by the phase modulators 708 can be representative of spin values in an Ising spin glass matrix and can be from −π to π, or alternatively, from 0 to 27 in the XY Hamiltonian model. The spin values/phases representing the values in the XY Hamiltonian model can represent an NP-hard problem or computationally hard/intensive problem modeled using the XY Hamiltonian model to the array elements 502 of the OPA 604.

The light travels to the antennas 504 through waveguides 506 and the antennas 504 emit the optical signal beams toward the focal plane array 802. The resulting emission pattern in the far field is imaged at the focal plane array 802. To find the Hamiltonian energy associated with a given configuration of spins (phases of optical signal beams emitted from the antennas 504), the brightness/intensity of the far field pattern is calculated by summing the pixel brightness in a periodic portion of the far field pattern at the focal plane array 802. The number of pixels in the focal plane array 802 does not bear a 1 to 1 relationship with the radiating pixels (e.g., antennas 504 or array elements 502) of the OPA 604, and in fact can be significantly fewer in number than the radiating pixels of the OPA 604. The calculation of the intensity can be done by the digital electronics 806 of the electronic feedback circuit electronically connected to the focal plane array 802. The electronic feedback circuit can be programmed to provide the feedback signal of the measured intensity by the focal plane array (FPA) to the electronic control circuit. The digital electronics 806 can include a non-transitory computer readable storage medium and a processor that executes instructions stored on the storage medium to calculate the Hamiltonian energy based on the pixel intensity observed in the far-field pattern at the focal plane array 802. The digital electronics can then provide a feedback signal based on the Hamiltonian energy to the DRIIC layer 510 to adjust the phases of the optical signal beams B from the antennas 502. The electronic control circuit (e.g., DRIIC layer 510) can be programmed to process the feedback signal from the electronic feedback circuit to adjust the setting of each of the optical phase modulators of the plurality of radiating pixels to the ground energy state of the Ising spin glass matrix mapped to the radiating pixels. After the phases are adjusted based on the feed back signal, the antennas 504 can again emit optical signal beams to the focal plane array 802, the focal plane array can output signals indicating intensity of the far field pattern to the digital electronics 806, and the digital electronics 806 can process the intensity of the far field pattern to provide another feedback signal to the DRIIC layer 510 for adjusting the phases of the antennas. This process can be repeated iteratively until the OPA arrives at the ground state energy for the encoded problem.

The iteration can be carried out as a genetic algorithm used to adjust the voltages applied to each phase modulator 708 to increase or reduce far field intensity to solve for the minimum or maximum intensity of the particular XY model. For example, the initial phases for each antenna 504 can be set a desired starting point or initial condition. The genetic algorithm can be used adjust the voltages applied to each phase modulator 708 and the phases of each of the optical signal beams emitted from the antennas 504 to reduce or increase far field brightness to iteratively solve for the maximum or minimum intensity of the XY model. Once the ground state energy level is found for the Ising model, the phases of each of the antennas 504 in the OPA can be retrieved using a Gerchberg-Saxton phase retrieval algorithm, using the constraint of a uniform array structure in the near field and using images of the far field interference pattern as the far field constraint. It is to be understood that any suitable phase retrieval algorithm can be used to retrieve the phase values of each radiating pixel at the ground state energy level to determine the solution for the Ising model mapped to the radiating pixels as an Ising spin glass matrix. The final phase values associated with the radiating pixels (e.g., array elements 502) of the OPA 604 at the minimum (or maximum) energy state of the XY model represent the solution for the NP hard problem mapped to the OPA as the XY problem.

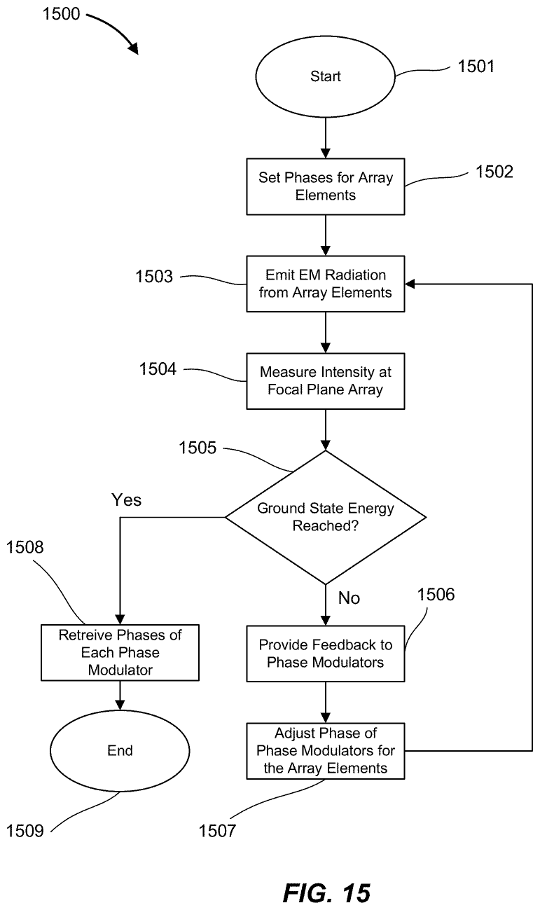

FIG. 15 illustrates exemplar operations and algorithms for calculating the ground energy state of an NP-hard problem mapped to either an Ising model or an XY Hamiltonian model. As described elsewhere in this disclosure, the photonic processor computing engines described herein can perform multiple computer implemented operations to solve NP-hard problems using Ising or XY Hamiltonian models. The engines (e.g., 800 and 900) described herein can include one or more memory devices (e.g., RAM, ROM, or any other non-transitory computer readable storage medium used to store software instructions) and one or more processors that execute the instructions stored in the memory to perform various operations. The memory devices and/or processors can be embedded in one or both of the electronic feedback circuit including digital electronics 806 and the DRIIC layer 510 (e.g., electronic control circuit). Furthermore, the memory devices and/or processors can alternatively be disposed away from the electronic feedback circuit and the electronic control circuit and instead provide instructions to each circuit via wired or wireless communication.

The processor can execute the instructions stored in memory to perform operations for the photonic processor computing engines described herein. The process of calculating a solution of a particular NP hard problem using an Ising model or XY Hamiltonian model is as illustrated in FIG. 15 and described as follows below. As shown in FIG. 15, the process can be a computer implemented method in which a processor executes instructions stored on a non-transitory computer readable storage medium. The processor and storage medium can be part of the photonic processor computing engines and/or photonic processor computing systems described herein.

The computer implemented method 1500 can include a step 1501 of starting the process. The method can further include a step of setting phase values for phase modulators 708 of the computing engine 800 based on an initial condition or to map to an Ising spin glass matrix or an XY Hamiltonian problem. For an Ising model, the phases can be either a first value of 0 or a second value of 7. For an XY Hamiltonian model, the phases can be any phase value between −π and π, or alternatively 0 to 2π. In step 1503, the method can cause the radiating pixels (e.g., array elements 502, antennas 504) to emit electromagnetic radiation provided by a laser source 602 and having a modulated phase (and optionally amplitude) based on the initial phase values set in step 1502. The emitted optical signal beams of electromagnetic radiation then reach the focal plane array 802. At step 1504, the intensity of the electromagnetic radiation reaching the focal plane array 802 can be measured and processed by the digital electronics 806. At this point, in step 1505, a calculation of the Hamiltonian energy can be made for the intensity to see if a ground state energy level has been reached for the Ising spin glass or the XY Hamiltonian model. If the answer is “No” then the method can proceed to step 1506 in which a feedback signal is provided to the phase modulators to adjust the phases of the array elements 502 to attempt to reach the ground state energy level. The phases may be adjusted based on a genetic algorithm designed to reach a ground state energy level for the system. For an Ising model, the phases can be either a first value of 0 or a second value of π. For an XY Hamiltonian model, the phases can be any phase value between −π and π, or alternatively 0 to 2π. At step 1507, the phases of the phase modulators 708 and array elements 502 can be recalibrated, at which point the process returns to step 1503 to emit light from the radiating pixels and to measure the intensity at the focal plane array 802. At step 1505, if the ground state energy is reached (e.g., “Yes” at step 1505) then the process proceeds to a step 1508 of retrieving the phase values for the phase modulators 708 of each of the array elements 502. The retrieved phase values represent the solution for the Ising model problem or the XY Hamiltonian problem mapped to the engine. At step 1509, the process ends.

It is to be understood that the method 1500 can be embodied in a photonic processor computing engine, a photonic processor computing engine system (e.g., engines 800 or 900 further including a laser source 602), a non-transitory machine readable storage medium, or as a computer implemented method.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein may be combined with other embodiments or features described herein, this disclosure should be read to describe any such combinations that would be practicable by one of ordinary skill in the art. The use of “or” in this disclosure should be understood to mean non-exclusive or, i.e., “and/or,” unless otherwise indicated herein.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A photonic processor computing engine device comprising:
a photonic integrated circuit (PIC) comprising:
an optical phased array (OPA) comprising a plurality of radiating pixels that radiate optical signal beams based on electromagnetic radiation, each of the plurality of radiating pixels comprising:
an optical antenna; and
an optical phase modulator; and
an electronic control circuit in electrical communication with the optical phased array (OPA) to calibrate and control the optical phase modulators of the optical phased array (OPA);
a focal plane array (FPA) positioned to receive the optical signal beams transmitted from the plurality of radiating pixels; and
an electronic feedback circuit in electrical communication with the focal plane array (FPA) and the electronic control circuit to process a measured intensity of the optical signal beams received by a defined portion of the focal plane array (FPA) from the optical phased array (OPA) and provide a feedback signal to the electronic control circuit based on the measured intensity for recalibrating the optical phase modulators of the plurality of radiating pixels to control the phase of the optical signal beams emitted by the plurality of radiating pixels.

2. A photonic processor computing engine device of claim 1, further comprising:
a lens assembly comprising one or more lenses and disposed between the photonic integrated circuit (PIC) and the focal plane array (FPA) to project the far field from the radiating pixels onto the focal plane array (FPA).

3. The photonic processor computing engine device of claim 1, comprising:
a plurality of layers including:
a photonic layer comprising the optical phased array (OPA); and
an electronic layer comprising the electronic control circuit disposed on a surface of the photonic layer, the electronic control circuit comprising a digital read-in integrated circuit (DRIIC) board in electrical communication with each of the optical phase modulators of the radiating pixels, the digital read-in integrated circuit being configured to apply voltages to control each of the optical phase modulators.

4. The photonic processor computing engine device of claim 3, wherein the electronic layer comprises one or more CMOS circuits.

5. The photonic processor computing engine device of claim 1, wherein the (PIC) further comprises:
a plurality of optical waveguides, each optically coupled to one of the plurality of radiating pixels of the optical phased array (OPA); and
a cascading waveguide tree comprising an electromagnetic radiation inlet configured to receive electromagnetic radiation from an electromagnetic radiation source, and a plurality of waveguide branches in optical communication with the electromagnetic radiation inlet and the plurality of optical waveguides.

6. The photonic processor computing engine device of claim 1, wherein the (PIC) further comprises:
a main optical waveguide in communication with an electromagnetic radiation source, and configured to receive electromagnetic radiation from the electromagnetic radiation source;
a plurality of branch optical waveguides each optically coupled to the main optical waveguide and two or more radiating pixels of the plurality of radiating pixels.

7. The photonic processor computing engine device of claim 1, wherein the electronic control circuit controls the optical phase modulators of the optical phased array (OPA) to map a computationally hard problem as an Ising spin glass matrix to the radiating pixels.

8. The photonic processor computing engine device of claim 7, wherein the electronic control circuit controls the optical phase modulators to have phase values of either 0 or π as Ising spin values for the Ising spin glass matrix mapped to the radiating pixels.

9. The photonic processor computing engine device of claim 8, wherein the PIC further comprises an optical attenuator or amplifier, and the electronic control circuit independently controls each of the optical phase modulators and attenuator or amplifiers to independently control an amplitude and phase of each of the optical signal beams of the plurality of radiating pixels to represent an Ising Spin Glass matrix of the Ising Spin Model mapped to the radiating pixels.

10. The photonic processor computing engine device of claim 9, wherein the electronic feedback circuit is programmed to provide feedback of the measured intensity of the optical signal beams received by at least a defined portion of the focal plane array (FPA) to the electronic control circuit, and the electronic control circuit is programmed to process the feedback to adjust the setting of each of the optical phase modulators of the plurality of radiating pixels.

11. The photonic processor computing engine device of claim 7, wherein the electronic control circuit controls the optical phase modulators to have phase values of from −π to π as values for an XY Hamiltonian model mapped to the radiating pixels.

12. The photonic processor computing engine device of claim 11, wherein the PIC further comprises an optical attenuator or amplifier, and the electronic control circuit independently controls each of the optical phase modulators and attenuators/amplifiers to independently control an amplitude and phase of each of the optical signal beams of the plurality of radiating pixels to represent an XY Hamiltonian model mapped to the radiating pixels.

13. The photonic processor computing engine device of claim 12, wherein the electronic feedback circuit is programmed to provide feedback of the measured intensity of the optical signal beams received by at least a defined portion of the focal plane array (FPA) to the electronic control circuit, and the electronic control circuit is programmed to process the feedback to adjust the setting of each of the optical phase modulators of the plurality of radiating pixels to a signal that correlates to the ground energy state of the XY Hamiltonian model mapped to the radiating pixels.

14. The photonic processor computing engine device of claim 1, the focal plane array (FPA) comprising a plurality of pixels, wherein the plurality of image pixels are fewer in number than the plurality of radiating pixels of the optical phased array (OPA).

15. The photonic processor computing engine device of claim 1, further comprising:
a plurality of the photonic integrated circuits (PIC), each comprising:
an optical phased array (OPA) comprising a plurality of radiating pixels that radiate optical signal beams based on electromagnetic radiation, each comprising:
an optical antenna; and
an optical phase modulator; and
an electronic control circuit in electrical communication with the optical phased array (OPA) to calibrate and control the optical phase modulators of the optical phased array (OPA);
wherein the focal plane array (FPA) is positioned to receive the optical signal beams transmitted from the plurality of radiating pixels of one or more of the plurality of photonic integrated circuits (PIC).

16. The photonic processor computing engine device of claim 15, further comprising:
a plurality of focal plane arrays (FPA), each positioned to receive the optical signal beams transmitted from the plurality of radiating pixels of one or more of the plurality of photonic integrated circuits (PIC).

17. A photonic processing system comprising:
an electromagnetic radiation source;
a photonic processor computing engine device comprising:
at least one photonic integrated circuit (PIC) comprising:
an optical phased array (OPA) comprising a plurality of radiating pixels that radiate optical signal beams based on electromagnetic radiation from the electromagnetic radiation source, each of the radiating pixels comprising:
an optical antenna; and
an optical phase modulator; and
at least one focal plane array (FPA) positioned to receive the optical signal beams transmitted from the plurality of radiating pixels;
at least one processor in electronic communication with the optical phase modulators and the focal plane array; and
a memory device including instructions that, when executed by the at least one processor, cause the system to:
measure an intensity of the optical signal beams received by a defined portion of the focal plane array (FPA) from the optical phased array (OPA);
provide a feedback signal to the optical phase modulators based on the measured intensity of the optical signal beams;
controlling the optical phase modulators of the plurality of radiating pixels to control the phase of the optical signal beams emitted by the plurality of radiating pixels to a condition correlated to a ground energy state; and
retrieving the phases of the optical phase modulators at the condition correlated to the ground energy state.

18. A computer implemented method of solving computationally hard problems using a photonic processor computing engine device comprising an optical phased array (OPA) and a focal plane array (FPA), the method comprising:
emitting optical signal beams from a plurality of radiating pixels of the optical phased array (OPA) to the focal plane array (FPA), each of the radiating pixels comprising an optical antenna and an optical phase modulator;
measuring an intensity of the optical signal beams received by a defined portion of the focal plane array (FPA) from the radiating pixels of the optical phased array (OPA);
providing a feedback signal to the optical phase modulators based on the measured intensity of the optical signal beams;
energizing the optical phase modulators of the plurality of radiating pixels to control the phase of the optical signal beams emitted by the plurality of radiating pixels to a condition correlated to a ground energy state; and
retrieving the phases of the optical phase modulators at a predetermined value of the intensity at the focal plane array.

19. The computer implemented method of claim 18, the method further comprising:
controlling, individually, each of the optical phase modulators such that optical signal beams radiating from each of the radiating pixels have binary phase values of either a first value or a second value;
providing feedback of the measured intensity of the optical signal beams received by a defined portion of the focal plane array (FPA) to the optical phase modulators; and
processing the feedback signal to recalibrate the optical phase modulators of the plurality of radiating pixels to the condition correlated to the ground energy state of the Ising spin glass mapped to the radiating pixels.

20. The method of claim 19, wherein the optical phase modulators have phase values of either 0 or π as Ising spin values for each radiating pixel.

21. The method of claim 20, wherein PIC further comprises an optical attenuator or amplifier, and each of the optical phase modulators and optical attenuators/amplifiers are independently controlled to control an amplitude and phase of each radiating optical signal beam of each of the plurality of radiating pixels to represent an Ising Spin Glass matrix of the Ising Spin Model mapped to the radiating pixels.

22. The method of claim 18, wherein the optical phase modulators have phase values from −π to π as values in the XY Hamiltonian model for each radiating pixel.

23. The method of claim 18, wherein PIC further comprises an optical attenuator or amplifier, and each of the optical phase modulators and optical attenuators/amplifiers are independently controlled to control an amplitude and phase of each radiating optical signal beam of each of the plurality of radiating pixels to represent an XY Hamiltonian model mapped to the radiating pixels.

24. A non-transitory machine-readable storage medium including instructions embodied thereon, wherein the instructions, when executed by at least one processor, cause a photonic processing engine comprising an optical phased array (OPA) and a focal plane array (FPA) to:
emit optical signal beams from a plurality of radiating pixels of the optical phased array (OPA) to the focal plane array (FPA), each of the radiating pixels comprising an optical antenna and an optical phase modulator;
measure an intensity of the optical signal beams received by a defined portion of the focal plane array (FPA) from the radiating pixels of the optical phased array (OPA);
provide a feedback signal to the optical phase modulators based on the measured intensity of the optical signal beams;
control the optical phase modulators of the plurality of radiating pixels to control the phase of the optical signal beams emitted by the plurality of radiating pixels to a condition that correlates to the ground energy state; and
retrieve the phases of the optical phase modulators at the condition that correlates to the ground energy state.

25. The non-transitory machine-readable storage medium of claim 24, wherein the instructions, when executed by at least one processor, further cause the photonic processing engine to:
individually control each of the optical phase modulators;
provide feedback of the measured intensity of the optical signal beams received by a defined portion of the focal plane array (FPA) to the optical phase modulators; and
process the feedback signal to recalibrate the optical phase modulators of the plurality of radiating pixels to a condition that correlates to the ground energy state of the Ising spin glass matrix mapped to the radiating pixels.

26. The non-transitory machine-readable storage medium of claim 25, wherein the photonic processing engine individually controls each of the optical phase modulators such that optical signal beams from each of the radiating pixels have binary phase values of either a first value or a second value, and the binary phase values are either 0 or π as Ising spin values for each radiating pixel.

27. The non-transitory machine-readable storage medium of claim 26, wherein the instructions, when executed by at least one processor, further cause the photonic processing engine to:
individually control phase (and amplitude) of each radiating optical signal beam of each of the plurality of radiating pixels to represent an Ising Spin Glass matrix of the Ising Spin Model mapped to the photonic processor computing engine device.

28. The non-transitory machine-readable storage medium of claim 25, wherein the optical phase modulators have phase values from −π to π as values in the XY Hamiltonian model for each radiating pixel.

29. The non-transitory machine-readable storage medium of claim 28, wherein the instructions, when executed by at least one processor, further cause the photonic processing engine to:
individually control phase (and amplitude) of each radiating optical signal beam of each of the plurality of radiating pixels to represent an XY Hamiltonian Model mapped to the photonic processor computing engine device.
